(19) United States
(12) Patent Application Publication
(10) Pub. No.: US 2012/0253840 A1
(43) Pub. Date: Oct. 4, 2012

(54) SYSTEM AND METHODS FOR ESTIMATING HBA1C, TREATMENT RESPONSE, AND HYPOGLYCEMIA RISK USING SELF-MONITORING OF BLOOD GLUCOSE DATA

(75) Inventor: Glen H. Murata, Albuquerque, NM (US)

(73) Assignee: STC.UNM, Albuquerque, NM (US)

(21) Appl. No.: 13/505,103

(22) PCT Filed: Oct. 25, 2010
(86) PCT No.: PCT/US10/53935

§ 371 Date: Apr. 30, 2012

Related U.S. Application Data
(60) Provisional application No. 61/343,604, filed on Apr. 30, 2010.
(60) Provisional application No. 61/284,496, filed on Dec. 21, 2009.

(51) Int. Cl. G06Q 50/22

(52) U.S. Cl. 705/2

(57) ABSTRACT

A system and method for estimating HbA1c, diabetic patient treatment response and hypoglycemia risk using data obtained from patient self-monitoring of blood glucose. The system includes a computer having a processor, data storage, display, and data input ports. The data storage stores an insulin manager module that has instructions performed by the processor when self-monitoring of blood glucose (SMBD) data is provided to the computer via one of the data input ports. The processor uses the SMBD data to generate reports displaying estimated HbAIc and other factors effecting blood glucose levels in a diabetic patient and prescribes insulin treatment plans.

### FIELD OF THE INVENTION

The present invention relates generally to insulin management in diabetic patients and, more specifically, to an automated system that uses patient self-monitoring of blood glucose to provide advisories to clinicians about the current level of glycemic control and projected impact of treatment modifications, identify and prioritize treatment targets, assess the risks of hypoglycemia before and after treatment, and select the most appropriate insulin and injection times.

### BACKGROUND OF THE INVENTION

Self-monitoring of blood glucose (SMBG) has become an integral part of diabetes management. Patients usually monitor their blood sugars at pre-determined times of the day. Providers then upload this data into office computers and use commercial software to calculate the glucose mean and standard deviation for specific time intervals. More advanced systems allow patients to label readings as pre- or postprandial and have sophisticated graphics. Although SMBG is expensive and represents a substantial patient burden, it has been surprisingly difficult to show that it improves glycemic control in patients. This difficulty has led to a growing sentiment that SMBG should not be recommended for all diabetic patients.

One problem is that conventional systems do not provide certain information that allows patient providers (e.g., physicians) to select the most appropriate treatment for patients. SMBG data would be far more useful if systems using this data determined the projected hemoglobin A1c (HbA1c) for a specific set (e.g. 2 weeks) of blood glucose readings. This response would help determine if a current treatment plan being applied to a patient is appropriate. HbA1c measures overall glycemic control in the preceding 10-12 weeks, but providers often titrate medications every 1-2 weeks. Although calculators are available on the Internet that convert HbA1c to mean glucose and vice-versa, the latter has to be calculated manually. In addition, these calculators use the arithmetic mean—an approach that overstates the influence of temporally clustered readings.

SMBG data would also be far more useful if a system could determine how much the HbA1c decreases when an abnormal reading is normalized. This response would help providers select the most effective treatment strategy. Protein glycation is a function of glucose concentration and exposure time, while treatment response is related to the amount that glucose is lowered and the duration of effect. Accordingly, treatment targets should not be defined as individual glucose readings. For example, fasting glucose is usually cited as the target for Glargine. However, Glargine's effect is due to a decrease in all basal readings for up to 24 hours.

SMBG data would further be far more useful if a system could determine the risk of hypoglycemia to patients. This response would help to assess the risks of insulin treatment. Conventional systems enumerate the hypoglycemic events in the past. However, the number of events is often a function of testing frequency (not risk) and may be due to conditions no longer present. A more informative approach is needed.

It is clear that there is a demand for a decision-support system utilizing SMBG data to improve the assessment and management of diabetic patients and which may overcome problems of the prior art to aid providers in making evidence-based decisions. The present invention satisfies these various demands.

### SUMMARY OF THE INVENTION

The present invention overcomes the problems of the conventional art described above. In particular, the present invention overcomes problems associated with interpreting SMBG data of diabetic patients. Specifically, the invention is based upon the fundamental observation that glycemic injury is a function of glucose concentration and exposure time and is therefore better addressed by an analysis of the areas under a 24-hour glucose profile than individual glucose readings. This approach is also far more consistent with the benefits of diabetes medications—which are related to the magnitude of glucose reduction and duration of effect.

The present invention provides a revolutionary approach to the interpretation of SMBG data that addresses the above problems. Instead of calculating an arithmetic mean, an embodiment of the present invention uses time-weighted glucose averages at selected points in the day to obtain a projected HbA1 c for a specific set of glucose readings.

In one embodiment, the present invention is based upon the area under a glucose concentration time curve (AUC). In another embodiment, the present invention is based upon a multiple linear model. Both methods of the present invention represent significant improvements over conventional methods because they define the independent contribution of individual readings to glycemic load and use weighted values to account for different exposure times. Users have the option of re-calculating the projected HbA1c after selecting one or more treatment targets. This approach identifies the readings that have the greatest impact on glycemic control and therefore are the highest treatment priorities.

Another embodiment of the present invention has treatment targets defined as areas under a glucose concentration time curve to determine how much the HbA1c will decrease if an abnormal reading is normalized. The invention calculates the fractional contribution of each target to excess glycemic load and therefore prioritizes treatment. The targets also delineate the required pharmacodynamic profiles (onset, duration, peak elevation, and shape) of the insulin preparations needed to normalize the glucose profile.

Another embodiment of the present invention uses a more informative approach to assess current risk of hypoglycemia by using advanced statistical treatment of readings at any given time of day. This approach is based upon log transformation of glucose values which are shown to be symmetrically distributed and heteroscedastic (i.e., of constant variance over a wide-range of glucose means). These observations suggest that the projected risk before and after treatment can be estimated as the area under a normal curve of log transformed values below a user-defined critical value.

Embodiments of the present invention allow the patient or provider to select a time frame or period of interest and choose from four analytical methodologies (one for each of the most common monitoring strategies). Specifying the date range allows the user to evaluate the effect of lifestyle modification or treatment changes on HbA1c in a manner currently not available. The embodiment also makes recommendations directed to type of insulin to be used and optimal injection times and allows treatment targets from two periods to be compared. Recommendations for treatment are derived by constructing timelines between possible insulin injection times and the target reading, comparing the pharmacokinetic properties of two insulin classes (regular and intermediate) with these parameters, and using two decision rules to select the best agent and injection time to provide information to providers for proscribing treatment plans to diabetic patients.

### BRIEF DESCRIPTION OF THE DRAWINGS

The preferred embodiments of the invention will be described in conjunction with the appended drawing provided to illustrate and not to the limit the invention, where like designations denote like elements, and in which:

FIG. 1 illustrates a system according to an embodiment of the present invention.

FIG. 2 shows an idealized glucose profile of a diabetic patient who consumes three meals daily;

FIG. 3 is an illustration of time intervals defined for the AUC method according to one embodiment of the present invention;

FIG. 4 shows a columnar arrangement of the area under the curve in FIG. 3;

FIG. 5A illustrates three main sources for an increase in AUC above normal;

FIG. 5B illustrates an exemplary abnormally high PPL;

FIG. 6 illustrates a basal hyperglycemia—the target for long-acting insulin;

FIG. 7 illustrates abnormal areas under the glucose profile attributed to pre-meal and bedtime hyperglycemia;

FIGS. 8A-D illustrate individual pre-meal and basal targets (morning, mid-day, afternoon, and evening);

FIGS. 9A-C illustrate postprandial targets for different time periods (breakfast, lunch, and dinner);

FIG. 10 shows how a reference point for calculating a postprandial excursion is determined using PPL as an example;

FIG. 11 shows a display of sampling times, glucose readings, elapsed time between measurements and meals, AUC, and HbA1c estimate based on the AUC method;

FIG. 12 illustrates factors that determine the contribution of glucose readings to the glycemic load;

FIG. 13 shows changes in blood glucose versus expected reduction in HbA1c for different readings;

FIG. 14 summarizes fractional contribution to AUC_{E} from the postprandial, pre-meal/bedtime, and basal hyperglycemia for a hypothetical patient;

FIG. 15 illustrates an exemplary analysis for a mid-day glucose elevation;

FIG. 16 shows expected changes in HbA1c for reductions in glucose elevations for eight different targets;

FIGS. 17A-E show defined treatment targets for the 4-point glucose profile;

FIGS. 18A-D show a display for the 4-point glucose profile similar to FIGS. 11-14;

FIGS. 19A-E shows displays for the 4-point glucose profile similar to FIGS. 15-16;

FIGS. 20A-C illustrate three targets for a 2-point glucose profile;

FIGS. 21A-B show data for a 2-point glucose profile similar to FIGS. 11-12;

FIGS. 22A-G show data for a 2-point glucose profile similar to FIGS. 13-16;

FIG. 23 shows targets for patients on Glargine/Lispro insulin combination;

FIG. 24 shows targets for patients on an NPH/regular insulin combination;

FIG. 25 illustrates a method by which providers interpret SMBG data and adjust insulin doses to patients;

FIG. 26 shows a more detailed description of Cycle 1 of FIG. 25; and FIG. 27 shows a more detailed description of Cycle 3 of FIG. 25.

### DETAILED DESCRIPTION OF PREFERRED EMBODIMENTS

Self-monitoring of blood glucose has become an integral part of diabetes management. Insulin treated patients usually obtain blood glucose values or readings at specific times of the day to measure the effects of insulin treatment. High blood glucose values indicate that the preceding insulin dose should be increased, while low readings suggest that the preceding dose was too high. For patients on combinations of Neutral Protamine Hagedom (NPH) insulin and regular insulin, the most common sampling times are before breakfast (PRB), before lunch (PRL), before dinner (PRD), and at bedtime (BED). The insulin Glargine has a sustained effect and may be titrated using PRB alone. On the other hand, the insulins Lispro, Aspart and Glulisine have a rapid onset but short duration of action and are used to treat postprandial (PP) hyperglycemia. PP glucose is usually measured 2 hours after breakfast (PPB), lunch (PPL), or dinner (PPD). Some providers advocate that patients test their blood glucose before and two hours after eating because the PP excursion reflects the glycemic load of the intervening meal. Accordingly, insulin-treated patients may generate a large number of readings clustered at 7 times of day: PRB, PPB, PRL, PPL, PRD, PPD, and BED.

As discussed above, there are problems with conventional systems that process SMBG data. One problem is that it is difficult to assess glycemic control from the large number of blood glucose readings. Another problem is treatment targets are not clearly identified. A third problem is conventional systems do not properly evaluate a patient's risk for hypoglycemia. Glucometers allow patients to review their individual readings and mean values for each sampling time. However, glycemic control is usually defined in terms of hemoglobin A1c (HbA1c). Moreover, most patients may not determine how their readings will eventually affect their HbA1c if the number or variability of readings is large.

HbA1c provides enough information about glycemic control to make treatment decisions. However, this is valid only if the behaviors or metabolic factors that affect blood glucose are relatively stable. Because HbA1c reflects glycemic control over the preceding 10-12 weeks, it may be affected by transient changes in glucose homeostasis that are no longer of concern. For example, if a patient has 6 weeks of gross dietary indiscretion followed by 6 weeks of a prudent diet, HbA1c overestimates the degree of hyperglycemia at the time of presentation. A related problem occurs with treatment planning. Providers often set goals for one or more blood glucose readings without any idea about whether these goals will achieve the desired HbA1c. Finally, waiting for HbA1c to equilibrate after each change impedes the process toward the goal. These problems may be eliminated if HbA1c may be estimated from glucose readings over a time frame of interest.

Another problem of conventional systems using SMBG data is that actual treatment targets are not identified. Conventional systems do not provide methods for estimating the contribution of readings to HbA1c. Accordingly, patients do not get clear feedback on when their glycemic control is most problematic. For example, it is not clear if a PRB of 160 mg/dL is more or less of a problem than a PPL of 240. The reason is that protein glycation depends upon glucose concentration and exposure times (which are greater for basal than PP readings). It would be far more useful to know that PRB contributes, say, 35% to the HbA1c, while the PPL contributes only 8%. In addition, the efficacy of an insulin preparation is related to its potency and duration of action, whereas blood glucose is measured at single points in time. As a result, the readings themselves may not be used to select the best treatment strategy. For example, using Glargine to lower PRB by 30 mg/dL is probably more effective than using Lispro to lower PPL by 60 mg/dL, even though the latter change is much larger. Because protein glycation and treatment effect are related to glucose changes and exposure times, it is desirable to define targets as areas under a glucose time curve (target areas). Each target area may be derived from SMBG data, and is characterized by onset, duration, shape, and size. The target areas may also be mutually exclusive and account for all incremental area above normal.

A large number of oral agents and insulin preparations are now available to treat hyperglycemia. Each class has distinct pharmacokinetic properties that make them suitable for certain circumstances but not for others. Successful treatment depends upon the extent to which the properties of the chosen agent match its intended target area in terms of onset, duration, and peak effect, if any. The present invention assists patients and providers with making these decisions.

Hypoglycemia is the most important barrier to dieting, exercise, and insulin treatment for many diabetic patients. Providers often evaluate this risk whenever any of these modalities are intensified. However, conventional systems generally count the number of hypoglycemic episodes over a certain time frame. However, this retrospective approach may expose patients to such complications before the risk may be fully characterized. In other situations, the interval of interest may be too short to capture any events. Finally, the number of episodes is a product of the risk and the number of readings taken. Low-risk patients who test frequently could have more episodes than high-risk patients who rarely monitor. These factors suggest that the preferred method for evaluating the risk of hypoglycemia risk should be prospective and based upon something other than counting hypoglycemic events.

The present invention offers a solution to the above problems. It allows the patient or provider to select a time frame of interest and choose from four different methodologies for each of the most common monitoring strategies. The system of the present invention may perform one or more of the following: project an HbA1c for the designated readings, estimate the effect on HbA1c of changing different readings, evaluate the risk of hypoglycemia, calculate the fractional contribution of each reading to glycemic load, identify the most important insulin targets, make recommendations for type of insulin and injection time; and allow treatment targets from two periods to be compared.

HbA1c may be calculated by two independent methods—one based upon the area under a glucose concentration time curve (AUC) and the other upon a multiple linear model. Both methods are improvements over conventional methods because they define the independent contribution of individual readings to glycemic load and use weighted values to account for different exposure times. Hypoglycemia rates may be forecast using pre-meal and bedtime glucose readings. A statistical analysis may be performed that presumes that readings at any time of day are log-normally distributed. Accordingly, it is possible to use a patient's data to construct such a distribution and generate probabilities that a random reading will fall below a series of specific values.

The system may derive the fractional contribution of each reading to HbA1c by using a trapezoidal estimation technique for AUC. Another embodiment calculates the proportion of estimated HbA1c attributed to each term in the previously mentioned multiple linear model. Recommendations for treatment are derived by constructing timelines between possible insulin injection times and the target reading, comparing the pharmacokinetic properties of regular and intermediate insulin types with these parameters, and using two decision rules to select the best type of insulin and insulin injection time.

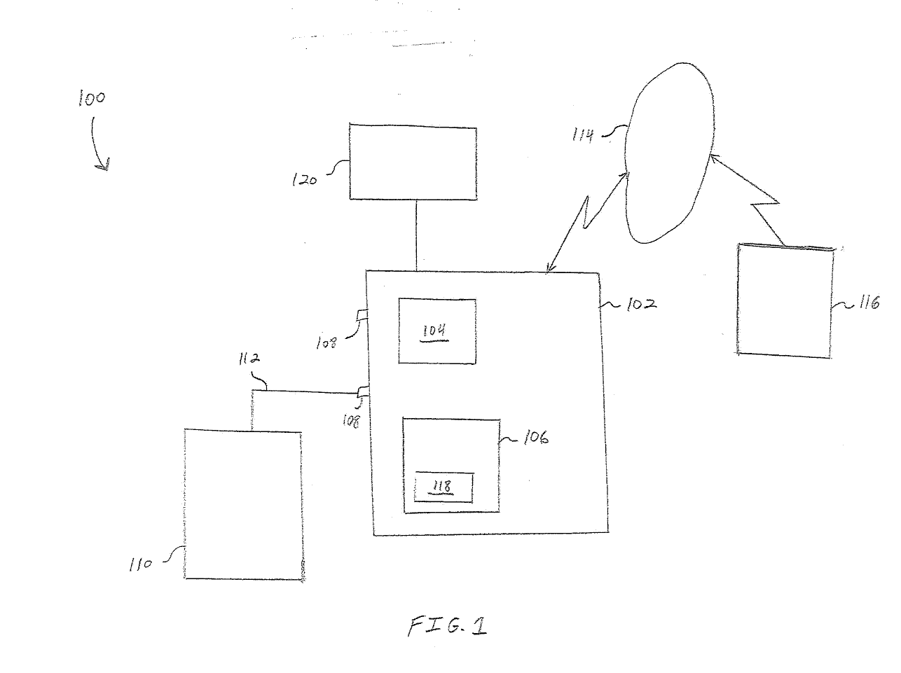

The system 100 shown in FIG. 1 may be a computer 102 that includes a processor 104 and memory 106. The computer 102 further includes one or more data ports 108 configured for receiving SMBG data. The SMBG data may be transferred from a patient glucometer 110 to the computer via a transmission line 112. Optionally, the computer 102 may be connected to the Internet 114 and receive SMBG data sent from a remote computer 116 that uploads the SMBG data from a glucometer (not shown). The memory 106 stores code, such as insulin manager module 118, which includes a set of instructions causing the processor 104 to perform a series of steps when executing the instructions. The system 100 also includes a display 120 that shows information as described below to assist the provider and/or patient with tailoring a treatment plan based on the patient's SMBG data.

The system allows the patient or provider to specify a time interval of interest and select from among 7-point, 4-point, 2-point, or 1-point glucose profiles. The profiles relate to times when readings are taken. For example, a 7-point profile utilizes data from seven reading times of a day, while a 4-point profile uses only four readings from a day. The system uses the SMBG data to project the HbA1c for a specified time interval and estimate the risk of hypoglycemia to a patient. The system also calculates the contribution of each reading to HbA1c, identifies treatment targets, and recommends a particular insulin type to be used by the patient and insulin injection times. Advantageously, the system further allows a side-by-side comparison of treatment targets from two different time periods of interest.

In the present application, “reading” is defined as a patient's average blood glucose at one of 7 testing times: PRB, PPB, PRL, PPL, PRD, PPD, and BED. “Sampling time” is defined as the customary time that a certain reading is taken, while “sampling interval” is defined as the time between two consecutive sampling times. The sampling interval may be chosen by a graphical method that has two points selected on a displayed graph, or start and stop times may be entered in data entry input boxes. The 7-point blood glucose profile is based upon readings taken before and two hours after each of three meals and at bedtime. The 4-point glucose profile uses values taken before meals and at bedtime, while the 2-point glucose profile requires readings before breakfast and dinner. The 1-point glucose profile is based upon a fasting measurement.

The algorithms of the system are performed on a sampling interval—that is, a contiguous period characterized by a starting and stopping point. Two methods are incorporated. The graphical method is based upon a display of individual readings over time. “Start” and “stop” arrows can be dragged and dropped to define an interval of interest. This approach allows the patient and provider to explore the effects of an observed pattern in the readings. The other choice allows the user to enter discrete start and stop dates. This method is more appropriate for behavioral changes or interventions affecting a known interval. If a date range is selected, the system provides the option of excluding specific dates within the interval. If such dates are identified, users may exclude one or all meals for each date. The reason is that treatment should be selected for the patient's customary behaviors—not for circumstances that are so atypical that they are not likely to recur. Examples include travel, illness, or celebrations associated with dietary indiscretion. Users may also choose to have weekdays and weekends treated separately. The timing and content of meals may markedly differ for these two groupings if the patient is working.

The system may use stored glucose values, the time that each specimen is taken, and the type of reading (e.g. PRB). Patients may download their SMBG data stored in glucometers into the database of the system. Readings may be retrieved from the specified time frame and a detailed profile may be developed for situations where there is adequate SMBG data stored in the database. The minimum stored data requirement may be specified by the provider or patient. In one embodiment, a default minimum SMBG data requirement is 4 measurements for each time of day. The required duration of monitoring blood glucose depends upon the number of readings taken per day and their distribution across testing times. For example, a 7-point glucose profile requires a minimum of 28 data points, which may be obtained in 14 days by testing twice daily on a rotating basis. On the other hand, the one-point glucose profile requires monitoring before breakfast for only 4 days. The system may use an event label to perform the following: determine the average sampling time and glucose value for each time of day; calculate the mean interval between readings; plot the points on a concentration versus time graph; constructs a profile by connecting the individual points with straight lines; and calculate AUC for the resulting plot.

The system of the present invention also considers that the consequences of hyperglycemia and the benefits of treatment are related to their effects on the glucose concentration time curve. Factors that increase AUC promote microvascular injury, while medications that decrease AUC lessen the risks. AUC may therefore be used to estimate HbA1c, the fractional contribution of each reading to glycemic load, and the size of different insulin targets. The area under the twenty-four hour glucose profile may be used to measure glycemic load. Glucose concentration and incubation time are clinically relevant variables that affect the extent of non-enzymatic protein glycation. The rate of accumulation of glycated end-products is proportional to the time integrated blood glucose level. HbA1c is directly proportional to the integrated blood glucose concentration as reflected in the twenty-four hour urinary glucose excretion or the sum of multiple daily glucose values.

PP glucose is a major determinant of glycemic load. However, this determinant ignores the contribution of meals other than breakfast and does not account for the fact that a diabetic patient spends the entire night in a fasting state. These unmeasured variables have opposite effects on the degree by which PP glucose contributes to glycemic load. Because glucose levels between sampling times are unknown, the system of the present invention may presume that glucose levels change in a linear fashion between two consecutive points. Glucose levels, their sampling times, and event labels may be used to construct a linear approximation of the 24-hour glucose profile for each patient. A linear approximation is preferably used because it requires the fewest assumptions, patients are unlikely to monitor blood glucose at a rate that provides greater detail, and there is some data showing linear changes having occurred in patients undergoing 24-hour glucose monitoring. However, non-linear approximations may also be used in the current system.

The system can calculate the AUC for the selected profile, measure the area attributed to the elevated glucose readings, and divide the latter into targets that may be used to select an insulin preparation. The targets are characterized by an onset, time to peak, duration, area, geometric configuration (triangular versus rectangular), and a vertical dimension representing the degree by which glucose should be lowered to eliminate the target. The areas reflect the fractional contribution of elevated readings to glycemic load and may be used to prioritize diabetic patient treatment.

Another embodiment of the present invention uses the previously mentioned multiple linear model to provide an independent estimate for HbA1c, a contribution of blood glucose readings to glycemic load, and a size of insulin targets. Previous attempts to correlate fasting (FG) and postprandial glucose (PPG) to glycemic load have led to conflicting results. Some studies have shown that PPG is a better correlate for HbA1c than FG, while others have found that the opposite is true. There is also great variation in the magnitude of the reported correlation coefficients for both parameters. The following table summarizes some published studies:

Correlation between HbA1c and FG versus PPG

| Author | Year | Subjects | Type | Challenge | FG | 2-hr PPG |
|---|---|---|---|---|---|---|
| Avignon A (16) | 1997 | 66 | 2 | standard meal | 0.62 | 0.81 |
| Soonthornpun S (17) | 1999 | 35 | 2 | standard meal | 0.46 | 0.51 |
| Guillausseau P J (18) | 1997 | 58 | 2 | standard meal | 0.39 | 0.56* |
| Prendergast C (19) | 1994 | 338 | 1/2 | none | 0.61 | 0.51 |
| ADA (Pima) (20) | 2001 | NS | 2 | variable** | 0.6-0.7 | 0.6-0.7 |
| ADA (trial) (20) | 2001 | NS | 2 | NS | 0.62-0.67 | 0.22-0.56 |
| Bouma M (21) | 1999 | 1,020 | 2 | none | 0.77 | — |
| Bonora E (22) | 2002 | 856 | 2 | usual meal | 0.48-0.65 | 0.45-0.58 |
| Rolfing C L (8) | 2002 | 1,439 | 1 | NS | 0.69 | 0.67-0.78* |

*1.5-hr PPG
**Glucose load or test meal

Most of these discrepancies are due to the use of different study designs. Some were longitudinal, while others were cross-sectional. Some used a standard glucose load, while in others, glucose samples were taken after an ordinary meal. Only two studies took precautions to assure that glucose measurements on the study day were representative of those in the weeks before the HbA1 c was drawn.

Avignon analyzed dietary habits using 7-day meal diaries 30 days prior to measuring blood glucose and HbA1c. The subjects were advised not to alter their diets until the study was completed. Bonora asked some of their subjects to test their blood glucose on five non-consecutive days over a period of one month. HbA1c was measured in the middle of the month. However, there are several reasons why a correlation analysis is not a rigorous way to evaluate this problem. Protein glycation occurs throughout the day at a rate that varies with the glucose concentration. Therefore, there is reason to correlate HbA1c to a single reading. This approach also does not account for exposure times, which is the other major determinant of protein glycation. A correlation coefficient measures how changes in an independent variable (e.g. FG) relate to changes in a dependent variable (HbA1c). This approach further provides no information about the actual amount that a reading contributes to glycemic load. FG and PPG are usually compared to HbA1c but not to each other. As a result, it is not possible to determine if their difference is statistically significant. Moreover, the contribution of PPG to glucose load is larger for patients eating 3 meals daily than those who eat only once. Finally, the relationship between HbA1c and any glucose reading is confounded. Because glucose readings tend to be correlated, part of the association between HbA1c and a specific reading may be due to the reading itself. However, the remainder could be due to its correlation with other readings that contribute to HbA1c. As a result, a large correlation coefficient does not mean that the reading of interest is highly influential, especially if the effects of the correlated values are substantial.

A more sophisticated method is needed for estimating the aggregate effect of multiple postprandial peaks. One more appropriate method for relating HbA1c to glucose readings is as embodiment of the present invention which uses the multiple linear model shown below.

$$HbA 1 c = constant + β 1 * PRB + β 2 * PPB + β 3 * PRL + β 4 * PPL + β 5 * PRD + β 6 * PPD + β 7 * BED$$

The parameters of the preceding equation are derived by fitting this model to data obtained from a reference population. “Fitting” is defined in this application as a mathematical process that derives the best estimate for HbA1c from observed readings. The estimate is partitioned among the independent variables and a constant representing the unmeasured sources. This regression method derives a coefficient for each predictor, tests its significance, and evaluates the degree to which the entire model explains the variation in glycemic control from patient to patient. The coefficients are weightings that adjust for the degree that each term contributes to the dependent variable HbA1c. There are several advantages to this method: it identifies the independent contribution of glucose readings taken at different times of the day; allows different weights to be assigned to the readings to reflect the different exposure times; may be used to predict the HbA1c for a given patient; and permits a direct comparison of the contribution of readings to glycemic load.

For a given patient:

HbA1c (observed)=HbA1c (estimate)+ε

where ε is defined as an error term that reflects the goodness-of-fit of the model.

The system may use HbA1c (estimate) to calculate the fractional contributions of different readings to HbA1c and size of the insulin targets. Using HbA1c (estimate) is reasonable as long as ε is small. HbA1c is generally tightly correlated to the mean of multiple readings taken in the day. Linear regression shows that mean glucose was strongly correlated with total glycosylated hemoglobin (r=0.93).

The system may generate inputs for a twenty-four hour glucose profile directly from uploaded glucometer data of a patient. Suppose a patient specifies an interval of interest defined by Date1 and Date2. For glucose values between Date1 and Date2:

1) For n_{PRB} values labeled “pre-breakfast”, PRB=(PRB₁+PRB₂ . . . PRB_{nPRB})/n_{PRB}

2) For n_{PPB} values labeled “postprandial breakfast”, PPB=(PPB₁+PPB₂ . . . PPB_{nPPB})n_{PPB}

3) For n_{PRL} values labeled “pre-lunch”, PRL=(PRL₁+PRL₂ . . . PRL_{nPRL})n_{PRL}

4) For n_{PPL} values labeled “postprandial lunch”, PPL=(PPL₁+PPL₂ . . . PPL_{nPP})n_{PPL}

5) For n_{PRD} values labeled “pre-dinner”, PRD=(PRD₁+PRD₂ . . . PRD_{nPRD})/n_{PRD}

6) For n_{PPD} values labeled “postprandial dinner”, PPD=(PPD₁+PPD₂ . . . PPD_{nPPD})n_{PPD}

7) For n_{BED} values labeled “bedtime”, BED=(BED₁+BED₂ . . . BED_{nBED})/n_{BED}

The following derivations are based upon 24-hour clock notation (or military time). To calculate sampling intervals, sampling times (STs) must increase in a monotonic fashion throughout the day. For persons awake during daylight hours and where BED occurs before 24:00, STs are given by:

1) ST_{PRB}=(ST_{PRB1}+ST_{PRB2} . . . +ST_{nPRB})/n_{PRB}

2) ST_{PPB}=(ST_{PPB1}+ST_{PPB2} . . . +ST_{nPPB})/n_{PPB}

3) ST_{PRL}=(ST_{PRL1}+ST_{PRL2} . . . +ST_{nPRL})/n_{PRL}

4) ST_{PPL}=(ST_{PPL1}+ST_{PPL2} . . . +ST_{nPPL})/n_{PPL}

5) ST_{PRD}=(ST_{PRD1}+ST_{PRD2} . . . +ST_{nPRD})/n_{PRD}

6) ST_{PPD}=(ST_{PPD1}+ST_{PPD2} . . . +ST_{nPPD})/n_{PPD}

7) ST_{BED}=(ST_{BED1}+ST_{BED2} . . . +ST_{nBED})/n_{BED}

For BED occurring after 24:00, ST_{BED}=ST_{BED}+24. For persons awake during the night, it may be necessary to shift the reference frame (e.g. 00:00 occurs 8 hours before PRB), so that sampling time (ST) increases for successive events.

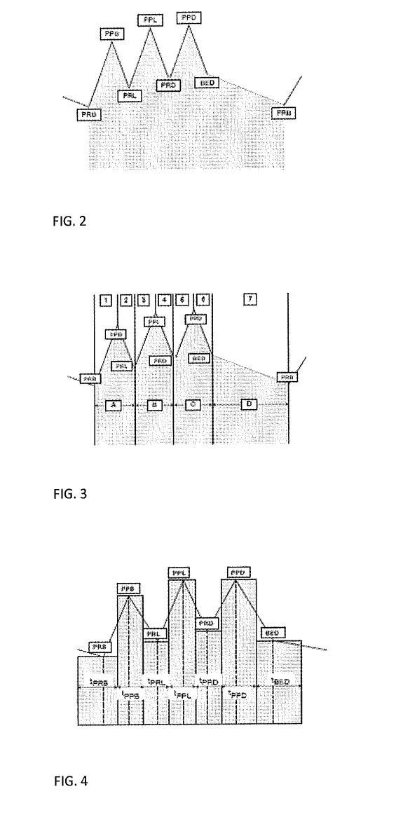

The system of the present invention may use the sampling intervals (SI) as shown in FIGS. 1-2. One set describes the average time elapsed between successive readings:
1) SI_{PRB-PPB} (or Interval 1)=ST_{PPB}−ST_{PRB}
2) SI_{PPB-PRL} (or Interval 2)=ST_{PRL}−ST_{PPB}
3) SI_{PRL-PPL} (or Interval 3)=ST_{PPL}−ST_{PRL}
4) SI_{PPL-PRD} (or Interval 4)=ST_{PRD}−ST_{PPL}
5) SI_{PRD-PPD} (or Interval 5)=ST_{PPD}−ST_{PRD}
6) SI_{PPD-BED} (or Interval 6)=ST_{BED}−ST_{PPD}
7) SI_{BED-PRB} (or Interval 7)=ST_{PRB}−ST_{BED}+24

Another set of SI describes the average time elapsed between the fasting, pre-meal and bedtime values:
1) SI_{PRB-PRL} (or Interval A)=ST_{PRL}−ST_{PRB}
2) SI_{PRL-PRD} (or Interval B)=ST_{PRD}−ST_{PRL}
3) SI_{PRD-BED} (or Interval C)=ST_{BED}−ST_{PRD}
4) SI_{BED-PRB} (or Interval D)=ST_{PRB}−ST_{BED}+24

An embodiment of the present invention using a 7-point glucose profile and AUC methodology is now considered for a diabetic patient who eats three meals daily. The patient's idealized glucose profile is shown in FIG. 2. In this illustration, a postprandial glucose peak occurs after each of 3 meals, followed by a long decline while the subject is sleeping. To determine an expression for AUC, it is necessary to define the time intervals shown in FIG. 3. A method for estimating the resulting area in FIG. 3 is to divide this figure into trapezoids, calculate the area for each trapezoid, and then add the areas together. The AUC is calculated by the following formula:

Total AUC=t_{PRB}*PRB+t_{PPB}*PPB+t_{PRL}*PRL+t_{PPL}*PPL+t_{PRD}*PRD+t_{PPD}*PPD+t_{BED}*BED [expression 1]

where tₙ is the mean of the sampling intervals immediately preceding and following reading n. In other words, t_{PRB}=½ (SI_{BED-PRB}+SI_{PRB-PPB}); t_{PPB}=½ (SI_{PRB-PPB}+SI_{PPB-PRL}); t_{PRL}=½ (SI_{PPB-PRL}+SI_{PRL}-_{PPL}); t_{PPPL}=½ (SI_{PRL-PPL}+SI_{PPL-PRD}); t_{PRD}=½ (SI_{PPL-PRD}+SI_{PRD-PPD}); t_{PPD}=½ (SI_{PRD-PPD}+SI_{PPD-BED}), and t_{BED}=½ (SI_{PPD-BED}+SI_{BED-PRB}). Expression 1 shows that AUC may be represented by the plot shown in FIG. 4.

The area under the original plot of FIG. 3 and the area represented by the columns are the same. The height of each column in the plot of FIG. 4 is the glucose value and its width the mean of the adjacent sampling intervals. The area of each column is the amount that the reading contributes to AUC. This method satisfies a requirement that the contribution of a reading to glycemic load is a function of exposure time. For most patients, bedtime and fasting values are given the most weight because they bracket the longest interval of the day, while PP readings are given the least weight. The total area and the fractional contribution of each reading may be quickly derived from the input data provided by a patient.

In order to predict HbA1c, reference values were derived from a known ADAG study that correlated blood glucose readings to HbA1c. The arithmetic mean blood glucose (AG) was related to HbA1c in the following manner:

AG=28.7×HbA1c−46.7 (R²=0.84; P<0.0001)

and will be referred to as the ADAG study equation in this application. For an embodiment of the present, AG=AUC/24. It is therefore possible to estimate HbA1c for a specified interval. For estimating the contribution of each reading to HbA1c, Expression 1 may be used to estimate the fractional contribution of the nth reading to AUC:

(tₙ*readingₙ)/Total AUC

The foregoing expression gives the proportion that reading n contributes to the glucose load from the 7 readings.

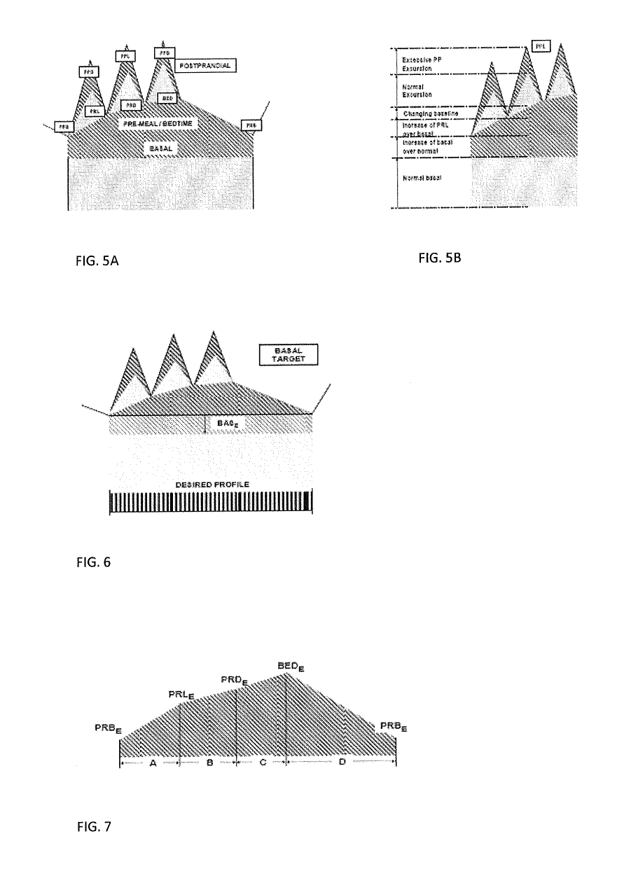

The system may identifying treatment targets by considering the manner in which different blood glucose readings contribute to HbA1c are defined. This is useful for identifying the readings that need to be treated. Generally, a most appropriate approach to identifying patient treatment targets depends upon how the patient became hyperglycemic. As shown in FIG. 5A, an increase in AUC above normal may be attributed to three sources, namely a basal elevation, pre-meal/bedtime elevations, and abnormally large postprandial excursions. The term “basal” as defined in this application refers to the patient's lowest blood glucose reading of the day.

Any reading may be the cumulative result of a variety of disturbances in glucose homeostasis. In the example shown in FIG. 5B, an abnormally high PPL may be due to an increase in basal glucose, an increase in PRL over basal, an upward drift in glucose between PRL and PRD, or a PP excursion that exceeds normal. The appropriate treatment depends upon which of these changes is the largest. A large PP excursion could be treated by Lispro given at lunch, an increase of PRL over basal by regular insulin given in the morning, and basal hyperglycemia by Glargine the night before. The most appropriate treatment may often differ using the present system from a proposed treatment determined from PPL alone.

The system may estimate the size of different insulin targets by decomposing the readings into their components and deriving time-weighted estimates of their fractional contribution to AUC. Basal glucose may expressed as an elevation over a “normal” value, pre-meal glucose may be expressed as an elevation over the basal value, and the postprandial glucose may be expressed as an elevation over a normal postprandial excursion. Collectively, these terms are defined in the present application as “elevations” over the reference values and designated by the subscript “E”. Basal (BAS) refers to the lowest value of PRB, PRL, PRD, and BED and represents the floor for the patient's daily glucose profile. The term Basil is defined in this manner so that all subsequent changes are positive deviations. The elevation of BAS over normal is indicated by BAS_{E}, while the elevations of PRB, PRL, PRD, and BED over BAS are represented by the terms PRB_{E}, PRL_{E}, PRD_{E}, and BED_{E}.

For the basal target, the system preferably gives priority to longer-acting insulins for larger targets over shorter-acting insulins for smaller targets. This is because the former requires fewer injections which lessens the burden on patients. Insulin targets are therefore defined for basal, then pre-meal or bedtime, and finally PP hyperglycemia. As shown in FIG. 6, basal hyperglycemia creates a flat target that lasts throughout the day. The target was designed for Glargine or overlapping injections of a shorter insulin preparation.

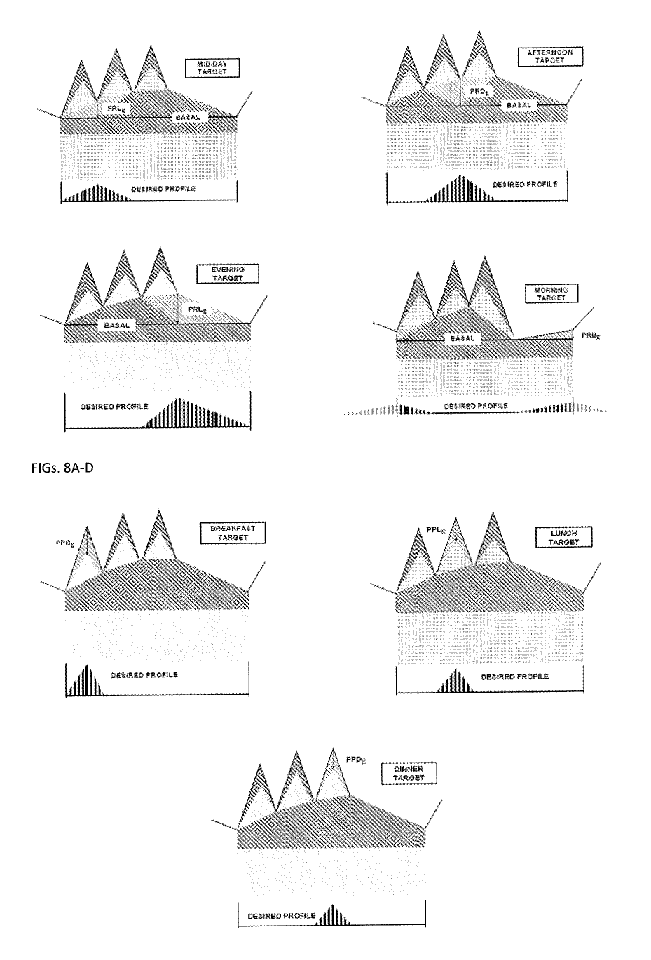

It is more difficult to identify targets attributable to pre-meal and bedtime glucose elevations because the geometry is more complex. However, these configurations include a series of trapezoids such as shown in FIG. 7. In addition, at least one of the elevations is the lowest reading of the day and would be considered the basal level. The value of lowest elevation would therefore be zero. Using a trapezoid rule, the area attributed to pre-meal and bedtime hyperglycemia is:

½*(Interval D+Interval A)*PRB_{E}½*(Interval A+Interval B)*PRL_{E}+½*(Interval B+Interval C)PRD_{E}½*(Interval C+Interval D)*BED_{E}

The above may divide the area into the targets shown in FIGS. 8A-D.

These configurations are selected because the area of each target is a product of the glucose elevation and the mean of the adjacent time intervals. This ensures that the contribution of a blood glucose reading to glycemic load is a function of glucose concentration and exposure time. The four targets account for the AUC from pre-meal and bedtime elevations. Each target conforms to the linearity assumption where readings change linearly between measurements before and after treatment.

The configurations are also selected because normalizing a glucose reading completely eliminates the target. Additionally, the targets may be used as references for selecting the correct treatment. Each target has an onset, time to peak, duration and a vertical dimension that increases and then decreases in a linear manner. All targets in this group are therefore best treated with preparations that have a triangular profile. The desired insulin profiles are also shown in FIGS. 8A-D.

In some circumstances it may or may not be possible to find a perfect treatment to match a particular profile. In the example above, the evening target requires a preparation with an early peak and long tail, while the morning target requires one with the opposite profile. However, best matching profiles may be selected to achieve the desired level of glycemic control.

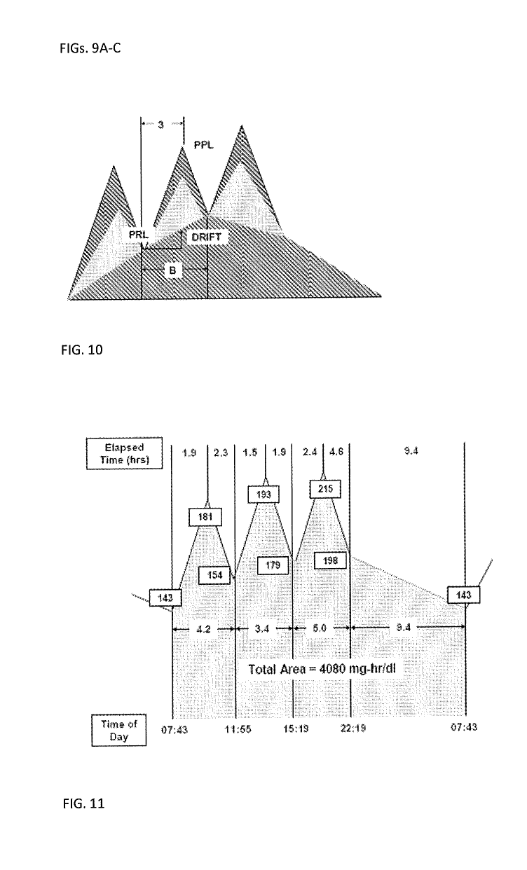

The postprandial targets are defined as shown in FIGS. 9A-C. PPE refers to the extent by which PP glucose exceeds the normal value (40 mg/dl). In FIG. 10, the reference point for PPL is the PRL plus the amount that PRL drifts upward by the time PPL is measured. The amount of drift is given by (Interval 3/B)*(PRD−PRL). PPLE is therefore given by the expression:

PPL_{E}=PPL−(PRL+[(Interval 3/Interval B)*(PRD−PRL)]+40)

Likewise:

PPB_{E}=PPB−(PRB+[(Interval 1/Interval A)*(PRL−PRB)]+40)

PPD_{E}=PPD−(PRD+[(Interval 5/Interval C)*(BED−PRD)]+40)

The area of each target is a product of the PP elevation and the mean of the adjacent sampling intervals. For example, area of the target created by PPBE is ½*(Interval 1+Interval 2)*PPB_{E}. As shown, the required insulin profile for the PP targets is triangular with a very short duration of action.

The area attributed to all glucose elevations (AUCE) is therefore the sum:

24*BAS_{E}+½*(Interval D+Interval A)*PRB_{E}+½*(Interval A+Interval B)*PRL_{E}+½*(Interval B+Interval C) PRD_{E}+½*(Interval C+Interval D)*BED_{E}+½*(Interval 1+Interval 2)*PPB_{E}+½* (Interval 3+Interval 4)*PPL_{E}+½*(Interval 5+Interval 6)*PPD_{E}

It is then possible to calculate the fractional contribution of each target to excess glycemic load as follows:
Basal: 24*BAS_{E}/AUC_{E}
Morning: ½*(Interval D+Interval A)*PRB_{E}/AUC_{E}
Mid-day: ½*(Interval A+Interval B)*PRL_{E}/AUC_{E}
Afternoon: ½*(Interval B+Interval C)PRD_{E}/AUC_{E}
Evening: ½*(Interval C+Interval D)*BED_{E}/AUC_{E}
Breakfast: ½*(Interval 1+Interval 2)*PPB_{E}/AUC_{E}
Lunch: ½*(Interval 3+Interval 4)*PPL_{E}/AUC_{E}
Dinner: ½*(Interval 5+Interval 6)*PPD_{E}/AUC_{E}

These values may be compared to identify the patient's major defect in glycemic control and adjustments in a treatment plan may be chosen accordingly.

Another embodiment of the present invention has regression methods that may be used to predict HbA1c since Expression 1 suggests that the relationship between HbA1c and the blood glucose readings should take the form of a multiple linear model containing all of the readings:

HbA1c=Constant+k_{PRB}*PRB+k_{PPB}*PPB+k_{PRL}*PRL+k_{PPL}*PPL+k_{PRD}*PRD+k_{PPD}*PPD+k_{BED}*BED [expression 2]

where kₙ is the regression coefficient for the nth term. Expression 2 is the mathematical expression of the glucose profile generated by the present embodiment because all points in the profile are linear functions of the seven readings. However, while AUC is based upon a biological construct, the linear model is a statistical treatment of the data. HbA1c may be estimated for the time frame of interest by substituting a patient's values into expression 2.

The system may estimate the contribution of each reading to HbA1c since Expression 2 may be used to determine the fractional contribution of each reading to glucose load. The fractional contribution of the nth value to the HbA1c attributable to the seven variables in the regression is given by:

kₙ*readingₙ/(Σkᵢ*reading)

The system can identify treatment targets since Expression 2 suggests that multiple linear regression is appropriate for analyzing the relationship between an increase in HbA1c (HbA1cE) and the “abnormal elevations” previously defined:

HbA1c_{E}=Constant+c_{BAS}*BAS_{E}+c_{PRBE}*PRB_{E}+c_{PRLE}*PRL_{E}+c_{PRDE}*PRD_{E}+c_{BEDE}*BED_{E}+c_{PPBE}*PPB_{E}+c_{PPLE}*PPL_{E}+c_{PPDE}*PPD_{E} [expression 3]

As in the previous example, the regression parameters are derived from the reference population. The fractional reduction in HbA1cE from normalizing any reading n is:

coefficientₙ*readingₙ/Σ coefficientᵢ*readingᵢ

The system allows treatment targets from two periods of interest to be compared side-by-side. This function is most useful for analyzing the effects of a new diet or treatment plan that a patient follows. Both the AUC and regression methods may be used to estimate target sizes for each period and differences can be displayed in tabular format.

The equations used by the system are provided below:

### AUC Method

a. AUC=t_{PRB}*PRB+t_{PPB}*PPB+t_{PRL}*PRL+t_{PPL}*PPL+t_{PRD}*PRD+t_{PPD}*PPD+t_{BED}*BED

Where:
t_{PRB}=½*(Interval 7+Interval 1)
t_{PPB}=½*(Interval 1+Interval 2)
t_{PRL}=½*(Interval 2+Interval 3)
t_{PPL}=½*(Interval 3+Interval 4)
t_{PRD}=½*(Interval 4+Interval 5)
t_{PPD}=½*(Interval 5+Interval 6)
t_{BED}=½*(Interval 6+Interval 7)

b. Estimated HbA1c (AUC)=constant+a*Total AUC

c. Fractional contribution to HbA1c of:
PRB: [tPRB*PRB]/[tPRB*PRB+tPPB*PPB+tPRL*PRL+tPPL*PPL+tPRD*PRD+tPPD*PPD+tBED*BED]
PRL: [tPRL*PRL]/[tPRB*PRB+tPPB*PPB+tPRL*PRL+tPPL*PPL+tPRD*PRD+tPPD*PPD+tBED*BED]
PRD: [tPRD*PRD]/[tPRB*PRB+tPPB*PPB+tPRL*PRL+tPPL*PPL+tPRD*PRD+tPPD*PPD+tBED*BED]
BED: [tBED*BED]/[tPRB*PRB+tPPB*PPB+tPRL*PRL+tPPL*PPL+tPRD*PRD+tPPD*PPD+tBED*BED]
PPB: [tPPB*PPB]/[tPRB*PRB+tPPB*PPB+tPRL*PRL+tPPL*PPL+tPRD*PRD+tPPD*PPD+tBED*BED]
PPL: [tPPL*PPL]/[tPRB*PRB+tPPB*PPB+tPRL*PRL+tPPL*PPL+tPRD*PRD+tPPD*PPD+tBED*BED]
PPD: [tPPD*PPD]/[tPRB*PRB+tPPB*PPB+tPRL*PRL+tPPL*PPL+tPRD*PRD+tPPD*PPD+tBED*BED]

d. AUCE=24*BAS_{E}+½*(Interval D+Interval A)*PRB_{E}½*(Interval A+Interval B)*PRL_{E}½*(Interval B+Interval C)PRD_{E}+½*(Interval C+Interval D)*BED_{E}½*(Interval 1+Interval 2)*PPB_{E}½*(Interval 3+Interval 4)*PPL_{E}+½*(Interval 5+Interval 6)*PPD_{E}

e. Fractional contribution to AUCE of:
Basal: 24*BAS_{E}/AUC_{E}
Morning: ½*(Interval D+Interval A)*PRB_{E}/AUC_{E}
Mid-day: ½*(Interval A+Interval B)*PRL_{E}/AUC_{E}
Afternoon: ½*(Interval B+Interval C) PRD_{E}/AUC_{E}
Evening: ½*(Interval C+Interval D)*BED_{E}/AUC_{E}
Breakfast: ½*(Interval 1+Interval 2)*PPB_{E}/AUC_{E}
Lunch: ½*(Interval 3+Interval 4)*PPL_{E}/AUC_{E}
Dinner: ½*(Interval 5+Interval 6)*PPD_{E}/AUC_{E}

### Regression Methods

a. HbA1c=Constant+k_{PRB}*PRB+k_{PPB}*PPB+k_{PRL}*PRL+k_{PPL}*PPL+k_{PRD}*PRD+k_{PPD}*PPD+k_{BED}*BED

b. Fractional contribution to HbA1c of:
PRB: [k_{PRB}*PRB]/[k_{PRB}*PRB+k_{PPB}*PPB+k_{PRL}*PRL+k_{PPL}*PPL+k_{PRD}*PRD+k_{PPD}*PPD+k_{BED}*BED]
PRL: [k_{PRL}*PRL]/[k_{PRB}*PRB+k_{PPB}*PPB+k_{PRL}*PRL+k_{PPL}*PPL+k_{PRD}*PRD+k_{PPD}*PPD+k_{BED}*BED]
PRD: [kPRD*PRD]/[k_{PRB}*PRB+k_{PPB}*PPB+k_{PRL}*PRL+k_{PPL}*PPL+k_{PRD}*PRD+k_{PRD}PPD+k_{BED}*BED]
BED: [k_{BED}*BED]/[k_{PRB}*PRB+k_{PPB}*PPB+k_{PRL}*PRL+k_{PPL}*PPL+k_{PRD}*PRD+k_{PPD}*PPD+k_{BED}+*Bed]
PPB: [k_{PPB}*PPB]/[k_{PRB}*PRB+k_{PPB}*PPB+k_{PRL}*PRL+k_{PPL}* PPL+k_{PRD}*PRD+k_{PPD}*PPD+k_{BED}*BED]
PPL: [k_{PPL}*PPL]/[k_{PRB}*PRB+k_{PPB}*PPB+k_{PRL}*PRL+k_{PP}L*PPL+k_{PRD}*PRD+k_{PPD}*PPD+k_{BED}*BED]
PPD: [k_{PPD}*PPD]/[k_{PRB}*PRB+k_{PPB}*PPB+k_{PRL}*PRL+k_{PPL}*PPL+k_{PRD}*PRD+k_{PPD}*PPD+k_{BED}*BED]

c. HbA1c_{E}=Constant+c_{BASE}*BAS_{E}+c_{PRBE}*PRB_{E}+c_{PRLE}*PRL_{E}+c_{PRDE}*PRD_{E}+c_{BEDE}*BED_{E}+c_{PPBE}*PPB_{E}+c_{PPLE}*PPL_{E}+c_{PPDE}*PPD_{E}

d. Fractional contribution to HbA1cE of:
Basal target: [c_{BASE}*BAS_{E}]/c_{BAS}_{E}+c_{PRDE}*PRB_{E}+c_{PRLE}*PRL_{E}+c_{PRDE}
PRD_{E}+c_{BEDE}*BED_{E}+c_{PPBE}*PPB_{E}+c_{PPLE}*PPL_{E}+c_{PPDE}*PPD_{E}]
Morning target: [c_{PRBE}*PPB_{E}/[c_{BASE}*BAS_{E}+c_{PRBE}*PRB_{E}+c_{PRLE}*PRL_{E}+c_{PRDE}*PRD_{E}+c_{BEDE}*BED_{E}+c_{PPB}_{E}+c_{PPLE}*PPL_{E}+c_{PPDE}*PPD_{E}]
Md-day target [c_{PRLE}*PRL_{E}]/[c_{BASE}*BAS_{E}+c_{PRBE}*PRB_{E}+c_{PRLE}*PRL_{E}+c_{PRDE}*PRD_{E}+c_{BEDE}*BED_{E}+c_{PPBE}*PPB_{E}+c_{PPLE}*PPL_{E}+c_{PPDE}*PPD_{E}]
Afternoon target: [c_{PRDE}*PRD_{E}]/[c_{BAS}E*BAS_{E}+c_{PRBE}*PRB_{E}+c_{PRLE}*PRL_{E}+c_{PRDE}*PRD_{E}+c_{BEDE}*BED_{E}+c_{PPBE}*PPB_{E}+c_{PPLE}*PPL_{E}+c_{PPDE}*PPD_{E}]
Evening target: [c_{BEDE}*BED_{E}]/[c_{BASE}*BAS_{E}+c_{PRBE}*PRB_{E}+d_{PRLE}*PRL_{E}+c_{PRDE}*PRD_{E}+c_{BEDE}*BED_{E}+c_{PPBE}*PPB_{E}+c_{PPLE}*PPL_{E}+c_{PPDE}*PPD_{E}]
Breakfast target: [c_{PPBE}*PPB_{E}]/[c_{BASE}*BAS_{E}+c_{PRBE}*PRB_{E}+c_{PRLE}*PRL_{E}+c_{PRDE}*PRD_{E}+c_{BEDE}*BED_{E}+c_{PPBE}*PPB_{E}+c_{PPLE}*PPL_{E}+c_{PPDE}*PPD_{E}]
Lunch target: [c_{PPLE}*PPL_{E}]/[c_{BASE}*BAS_{E}+c_{PRBE}*PRB_{E}+c_{PRLE}*PRL_{E}+c_{PRDE}*PRD_{E}+c_{BEDE}*BED_{E}+c_{PPBE}*PPB_{E}+c_{PPLE}*PPL_{E}+c_{PPDE}*PPD_{E}]
Dinner target: [c_{PPDE}*PPD_{E}]/[c_{BASE}*BAS_{E}+c_{PRBE}*PRB_{E}+c_{PRLE}*PRL_{E}+c_{PRDE}*PRD_{E}+c_{BEDE}*BED_{E}+c_{PPBE}*PPB_{E}+c_{PPLE}*PPL_{E}+c_{PPDE}*PPD_{E}]

The system of the present invention provides an analysis in the form of seven displays. The first display illustrated in FIG. 11 shows sampling times, glucose readings, elapsed time between measurements and meals, AUC, and an estimate for HbA1c based upon the AUC method. The display provides a quick orientation to the parameters obtained during the period of interest.

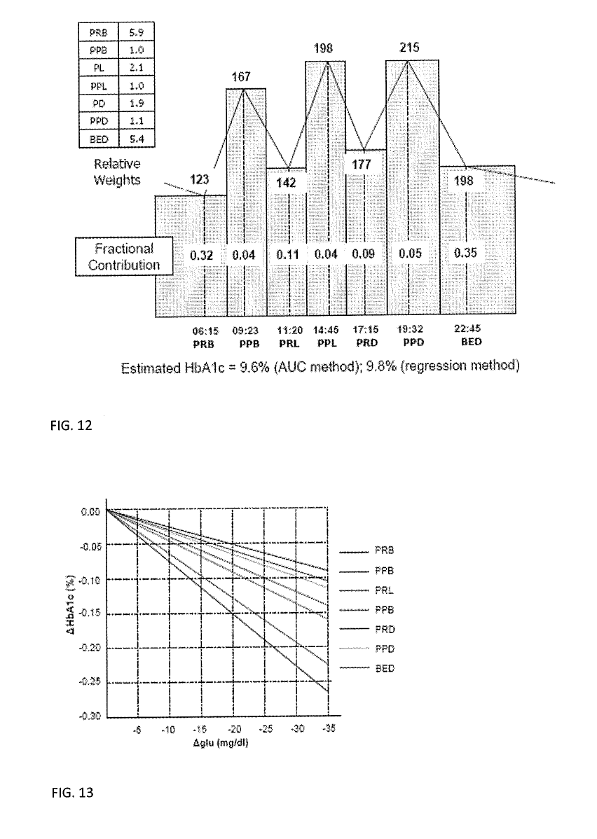

The next display shown in FIG. 12 allows the patient or provider to get an immediate analysis of the factors that determine the contribution of blood glucose readings to glycemic load. The height of each bar represents the blood glucose value, while the width is the average of the adjacent sampling intervals. The area is the degree to which the reading contributes to total AUC. The fractional contribution is shown in each column.

FIG. 13 illustrates that the readings are not of equal influence in determining HbA1c. Changes in blood glucose are plotted on the x-axis and the expected reduction in HbA1c on the y-axis for the different readings. Note that the decline in HbA1c is much steeper for a given change in BED than the same change in PRL.

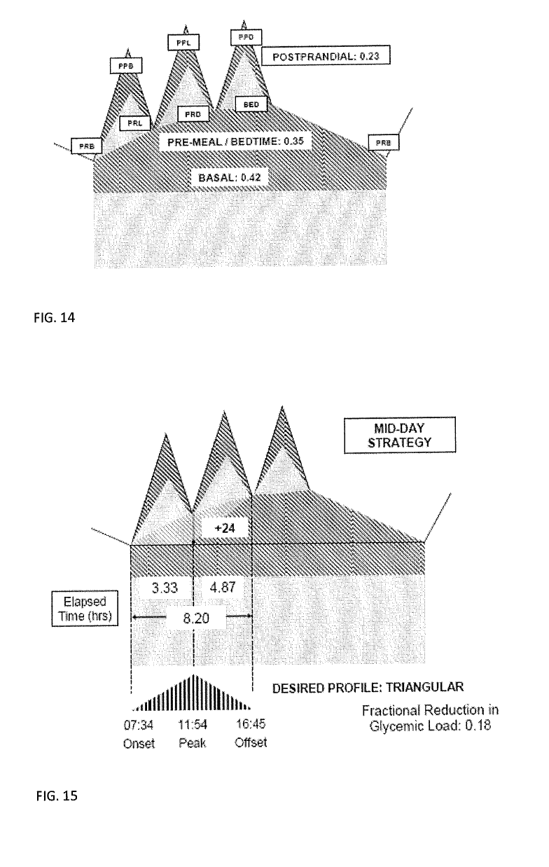

FIG. 14 identifies a patient's major problem with glycemic control. FIG. 14 shows the fractional contribution to AUC_{E} from the postprandial, pre-meal/bedtime, and basal hyperglycemia. For example, the fractional contribution from the 3 PP peaks is 0.23, while the basal elevation accounts for 0.42. This suggests to a provider that the major defect is basal hyperglycemia.

The following table provides more detail about contributors to AUC_{E}:

Contribution of Glucose Elevations to AUC_{E}

| | Value | Time- | Fractional |
|---|---|---|---|
| Elevation | (mg/dl) | weighting | Contribution |
| BAS_{E} | +24 | 24.0 | 0.557 |
| PRB_{E} | +8 | 6.3 | 0.049 |
| PPB_{E} | +12 | 1.1 | 0.013 |
| PRL_{E} | +15 | 3.2 | 0.046 |
| PPL_{E} | +13 | 1.2 | 0.015 |
| PRD_{E} | +22 | 4.1 | 0.087 |
| PPD_{E} | +17 | 1.8 | 0.030 |
| BED_{E} | +39 | 5.4 | 0.204 |

Value refers to the vertical dimension of the target and represents the degree to which the reading is elevated over its reference value. Time-weighting is the mean of the adjacent sampling intervals. The product of Value and Time-weighting is the target area. “Fractional contribution” is the degree by which the target area contributes to AUCE and is preferably used for prioritizing treatment.

FIG. 15 shows a corresponding detailed display of the target for one of the rows of FIG. 14. More specifically, the mid-day target is displayed in FIG. 15. The vertical dimension is the degree by which PRL should be lowered to eliminate the target. Elapsed time refers to the time from onset to peak and from peak to offset. The required insulin profile is shown below the figure. Also displayed is the expected fractional reduction in glycemic load when the target is eliminated. Thus, an insulin preparation that has an onset at 7:34 AM, peaks at 11:54 AM, lasts 8.2 hours, has a triangular profile, and lowers PRL by 24 mg/dl will result in a fractional reduction in glycemic load of 0.18.

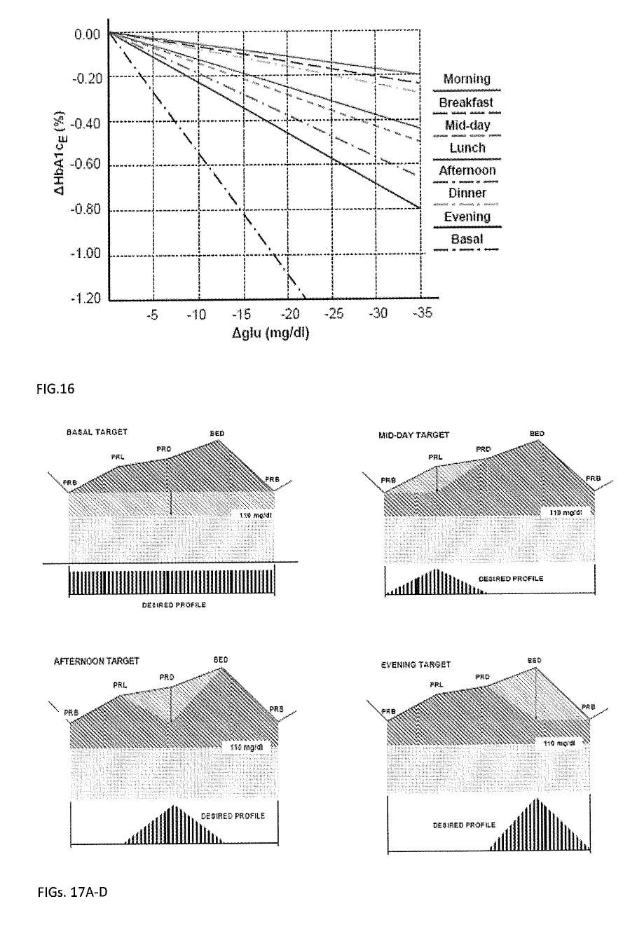

The plots shown in FIG. 16 illustrate the expected changes in HbA1c_{E} (y-axis) for reductions in glucose elevations (x-axis) for each of the eight targets. The most rapid decline is seen with treatment of basal hyperglycemia.

The following tables compare treatment targets from two periods of interest:

CONTRIBUTION OF TARGETS TO AUC (mg · hr/dl): Period 1 versus 2

| Target | Δ glu | Area 1 | Area2 | Difference | % Change |
|---|---|---|---|---|---|
| All postprandial | +3 | 122 | 100 | −22 | −18.0% |
| Breakfast | −12 | 20 | 26 | +6 | +30.0% |
| Lunch | −2 | 36 | 12 | −24 | −67.7% |
| Dinner | | 66 | 62 | −4 | −3.3% |
| Pre-meal/bedtime | +1 | 204 | 220 | +16 | +7.8% |
| Morning | +12 | 32 | 36 | +4 | +11.1% |
| Mid-day | −4 | 40 | 88 | +48 | +120% |
| Afternoon | −5 | 60 | 44 | −16 | −26.7% |
| Evening | −20 | 72 | 52 | −20 | −27.8% |
| Basal | | 720 | 240 | −480 | −66.7% |
| All targets | | 1046 | 580 | −486 | −46.5% |
| Estimated HbA1c | | 8.62 | 7.95 | −0.67 | −7.78% |

CONTRIBUTION OF TARGETS TO HBA1C_{E}: Period 1 versus 2

| Target | Δ glu | Period 1 | Period 2 | Diff | % Change |
|---|---|---|---|---|---|
| All postprandial | | 0.93% | 0.71% | −0.22% | −23.7% |
| Breakfast | +3 | 0.18% | 0.19% | +0.01% | +5.6% |
| Lunch | −12 | 0.42% | 0.21% | −0.21% | −50.0% |
| Dinner | −2 | 0.33% | 0.31% | −0.02% | −6.1% |
| Pre-meal/bedtime | | 0.37% | 0.48% | 0.11% | +29.7% |
| Morning | +1 | 0.22% | 0.23% | +0.01% | +4.5% |
| Mid-day | +12 | 0.14% | 0.25% | +0.11% | +78.6% |
| Afternoon | −4 | 0.01% | 0.00% | −0.01% | −100% |
| Evening | −5 | 0.26% | 0.23% | −0.03% | −11.5% |
| Basal | −20 | 1.84% | 1.67% | −0.17% | −9.2% |
| All targets | | 3.14% | 2.86% | −0.28% | −8.9% |
| Estimated HbA1c | | 8.62 | 7.95 | −0.67 | −7.78% |

The left table shows the contribution of targets to AUC while the right table shows target contributions to HbA1c. For each target, the following information is displayed: the glucose elevation, the amount that the target contributes to AUC or HbA1c for the first period, the amount that the target contributes to AUC or HbA1c for the second period, difference between the target sizes, and percent and direction of change. The tables also describe the collection contribution from all PP, all pre-meal/bedtime, and all targets to glycemic load. This analysis allows the provider or patient to precisely identify the changes that result from changes in diet or treatment.

The system may use a 4-point glucose profile and AUC methodology for determining a treatment plan for a diabetic patient. The 4-point glucose profile (PRB, PRL, PRD, and BED) is less robust for estimating HbA1c and treatment response because no information is obtained about PP excursions. Differences in PP between the patient and reference population could limit the effectiveness of prescribed treatment plans. Formulas for the 4-point glucose profile are derived in the same manner as those for the 7-point glucose profile.

For predicting HbA1c, the AUC for a 4-point profile is given by the expression:

AUC=½*(Interval D+Interval A)*PRB+½*(Interval A+Interval B)*PRL+½*(Interval B+Interval C)*PRD+½*(Interval C+Interval D)+BED

where tₙ is the mean of the sampling intervals around observation n. The estimated HbA1c for the patient may be obtained by substituting his or her AUC into the ADAG study equation.

For estimating the contribution of each reading to HbA1c, the fractional contribution of each reading to HbA1c is given by the following:

(tₙ*readingₙ)/AUC

where tₙ is the mean of the adjacent sampling intervals.

For identifying treatment targets using re-parameterization, AUCE is given by the formula:

AUCE=24*BASE+½*(Interval D+Interval A)*PRBE+½*(Interval A+Interval B)*PRLE+½*(Interval B+Interval C)*PRDE+½*(Interval C+Interval D)BEDE

The fractional reduction in HbA1cE by normalizing reading n is therefore given by:

coefficientₙ*elevationₙ/AUC_{E}.

Other embodiments of the present invention use regression methods. In these embodiments, the expression relating HbA1c to the four readings is:

HbA1c=Constant+k_{PRB}*PRB+k_{PRL}*PRL+k_{PRD}*PRD+k_{BED}*BED

The patient's HbA1c may be estimated from the above expression by substituting his or her values. The parameters are derived from a population-based study.

For estimating the contribution of each reading to HbA1c, the fractional contribution of each reading may be obtained directly from the above formula:

kₙ*reading n/(Σkᵢ*readingᵢ)

For identifying treatment targets, from the formula for AUCE the most appropriate formula for HbA1c_{E} is:

HbA1c_{E}=Constant+c_{BASE}*BAS_{E}+c_{PRB}*PRB_{E}+c_{PRL}*PRL_{E}+c_{PRD}*PRD_{E}+cB_{ED}*BED_{E}

where the coefficients are derived from the population study. The fractional reduction in HbA1c from normalizing elevation n is given by:

coefficientₙ*readingₙ/Σ coefficientᵢ*readingᵢ

Parameters for the 4-point model were developed from a prospective, observational study of 150 subjects on stable doses of insulin selected at random from pharmacy records at three major medical centers. Subjects were asked to check their blood glucose before breakfast, lunch, and dinner and at bedtime for eight weeks. At the conclusion of this period, blood samples were obtained for HbA1c. Multiple linear regression was used to examine the relationships between HbA1c and the following: AUC; a fitted model consisting of the four readings; and the mean of the four readings. The results are as follows:

HbA1c versus AUC (r = 0.792; P < 0.001)

| Variable | Coefficient | Std Deviation | Tolerance | P-value |
|---|---|---|---|---|
| Constant | 2.440 | 0.358 | — | <0.001 |
| AUC | 0.00122 | 0.00008 | 1.000 | <0.001 |

HbA1c versus 4-point model (R = 0.789; P < 0.001)

| Variable | Coefficient | Std Deviation | Tolerance | P-value |
|---|---|---|---|---|
| Constant | 2.434 | 0.345 | — | <0.001 |
| PRB | 0.00906 | 0.00250 | 0.455 | <0.001 |
| PRL | 0.00547 | 0.00259 | 0.378 | 0.036 |
| PRD | 0.00576 | 0.00265 | 0.323 | 0.032 |
| BED | 0.00892 | 0.00222 | 0.525 | <0.001 |

HbA1c versus glucose mean (R = 0.787; P < 0.001)

| Variable | Coefficient | Std Deviation | Tolerance | P-value |
|---|---|---|---|---|
| Constant | 2.518 | 0.328 | — | <0.001 |
| Mean glucose | 0.02874 | 0.00185 | 1.0000 | <0.001 |

This analysis shows that the advantage of using the AUC method and explains the 0.4% to 0.7% increase of the variance in HbA1c than in conventional models consisting of individual or mean glucose values. Moreover, the coefficients in the multiple linear model indicate that PRB and BED are significantly more influential in determining HbA1c than the daytime readings. This finding is consistent with the principle that readings bracketing the longest time interval should be given more weight because of increased exposure time. The analysis was repeated for HbA1c_{E}:

HbA1c_{E} versus model (r = 0.792; P < 0.001)

| Variable | Coefficient | Std Deviation | Tolerance | P-value |
|---|---|---|---|---|
| Constant | −0.440 | 0.170 | — | 0.011 |
| BAS_{E} | 0.02828 | 0.00206 | 0.911 | <0.001 |
| PRB_{E} | 0.01303 | 0.00404 | 0.971 | 0.002 |
| PRL_{E} | 0.00624 | 0.00266 | 0.856 | 0.020 |
| PRD_{E} | 0.00670 | 0.00275 | 0.734 | 0.016 |
| BED_{E} | 0.00938 | 0.00225 | 0.768 | <0.001 |

This analysis shows that the elevation in basal glucose is 4 times more influential in determining HbA1c_{E} than an increase of PRL or PRD over the basal reading. This result indicates that PRL_{E} or PRD_{E} would have to be four times greater than BAS_{E} before treatment of PRL or PRD takes precedence over normalizing the basal value.

The models were validated by a split-sample technique. A random number generator was used to divide the sample into derivation (97 subjects) and validation sets (53 subjects). Predicted values for HbA1c and HbA1c_{E} were calculated for the validation set by substituting patient values into the new models. Linear regression was then used to examine the relationship between predicted and observed outcomes. The observed HbA1c in the validation set (7.55±1.62%) was somewhat lower than that predicted by the AUC method (7.60±1.56%) and 4-point model (7.61±1.55%). However, correlations between observed and predicted HbA1c from the two methods were high (r=0.835 and 0.829, respectively; P<0.001). Similar results were obtained for HbA1c_{E}. The observed value (+1.55±1.62%) was again lower than that predicted by the AUC method (+1.62±1.57%) and 4-point model (+1.61±1.55%). However, the correlations were again very high (r=0.843 and 0.832, respectively; P<0.001). The correlations are equal to those observed between HbA1c and direct glucose measurements.

The entire sample (n=150) was used to cross-validate the fractional contributions of the 4 readings to total HbA1c:

Contributions of readings to HbA1c

| Reading | AUC Method | Model | R | P-value |
|---|---|---|---|---|
| PRB | 26.5 ± 4.4% | 27.4 ± 3.8% | 0.874 | <0.001 |
| PRL | 21.2 ± 3.4% | 18.4 ± 2.7% | 0.647 | <0.001 |
| PRD | 20.3 ± 3.5% | 19.9 ± 2.5% | 0.743 | <0.001 |
| BED | 31.9 ± 5.0% | 34.3 ± 4.3% | 0.830 | <0.001 |

The two sets of values were tightly correlated. The AUC method uses the patient's own mealtimes, while the model uses population time weightings. The lower correlations for PRL and PRD suggest that there is greater variability in the timing of these meals than for breakfast or bed. Fractional contributions of the five elevations to excess HbA1c are used to estimate the effect of normalizing abnormal readings at different times. The two methods for estimating these contributions were therefore cross-validated.

| Reading | AUC Method | Model | R | P-value |
|---|---|---|---|---|
| BAS_{E} | 45.1 ± 28.4% | 42.1 ± 27.4% | 0.998 | <0.001 |
| PRB_{E} | 6.1 ± 10.5% | 7.8 ± 12.6% | 0.993 | <0.001 |
| PRL_{E} | 10.1 ± 10.6% | 9.7% ± 10.2% | 0.986 | <0.001 |
| PRD_{E} | 11.6 ± 10.7% | 12.2 ± 10.7% | 0.984 | <0.001 |
| BED_{E} | 27.2 ± 19.1% | 28.3 ± 19.2% | 0.991 | <0.001 |

For the AUC method, the following equations are used.

AUC=t_{PRB}*PRB+t_{PRL}*PRL+t_{PRD}*PRD+t_{BED}*BED

where:
t_{PRB}=½ (Interval D+Interval A)
t_{PRL}=½ (Interval A+Interval B)
t_{PRD}=½ (Interval B+Interval C)
t_{BED}=½ (Interval C+Interval D)

Estimated HbA1c=2.440+0.00122*Total AUC

Fractional contribution to HbA1c of:
PRB: [t_{PRB}*PRB]/[t_{PRB}*PRB+t_{PRL}*PRL+t_{PRD}*PRD+t_{BED}*BED]
PRL: [t_{PRL}*PRL]/[t_{PRB}*PRB+t_{PRL}*PRL+t_{PRD}*PRD+t_{BED}*BED]
PRD: [t_{PRD}* PRD]/[t_{PRB}*PRB+t_{PRL}*PRL+t_{PRD}*PRD+t_{BED}*BED]
BED: [t_{BED}*BED]/[t_{PRB}*PRB+t_{PRL}*PRL+t_{PRD}*PRD+t_{BED}*BED]

AUC_{E}=2*BAS_{E}+t_{PRB}*PRB_{E}+t_{PRL}*PRL_{E}+t_{PRD}*PRD_{E}+t_{BED}*BED_{E}

Fractional contribution to HbA1c_{E} of:
Basal target: [24*BAS_{E}]/[24*BAS_{E}+t_{PRB}*PRB_{E}+t_{PRL}*PRL_{E}+t_{PRD}*PRD_{E}+t_{BED}*BED_{E}]
Morning target: [tp_{RB}*PRB_{E}]/[24*BAS_{E}+t_{PRB}*PRB_{E}+t_{PRL}*PRL_{E}+t_{PRD}*PRD_{E}+t_{BED}*BED_{E}]
Mid-day target: [t_{PRB}*PRL_{E}]/[24*BAS_{E}+t_{PRB}*PRB_{E}t_{PRL}*PRL_{E}+t_{PRD}*PRD_{E}+t_{BED}*BED_{E}]
Afternoon target: [t_{PRD}*PRD_{E}]/[24*BAS_{E}+t_{PRB}*PRB_{E}t_{PRL}*PRL_{E}+t_{PRD}*PRD_{E}+t_{BED}*BED_{E}]
Evening target: [t_{BED}*BED_{E}]/[24*BAS_{E}+t_{PRB}*PRB_{E}+t_{PRL}*PRL_{E}+t_{PRD}*PRD_{E}+t_{BED}*BED_{E}]
   For the regression method, the following equations are used.

HbA1c=2.434+0.00906*PRB+0.00547*PRL+0.00576*PRD+0.00892*BED

Fractional contribution to HbA1c of:
PRB: [0.00906*PRB]/[0.00906*PRB+0.00547*PRL+0.00576*PRD+0.00892*BED]
PRL: [0.00547*PRL]/[0.00906*PRB+0.00547*PRL+0.00576*PRD+0.00892*BED]
PRD: [0.00576*PRD]/[0.00906*PRB+0.00547*PRL+0.00576*PRD+0.00892*BED]
BED: [0.00892*BED]/[0.00906*PRB+0.00547*PRL+0.00576*PRD+0.00892*BED]

HbA1cE=−0.440+0.02828*BASE+0.01303*PRBE+0.00624*PRLE+0.00670*PRDE+0.00938*BEDE

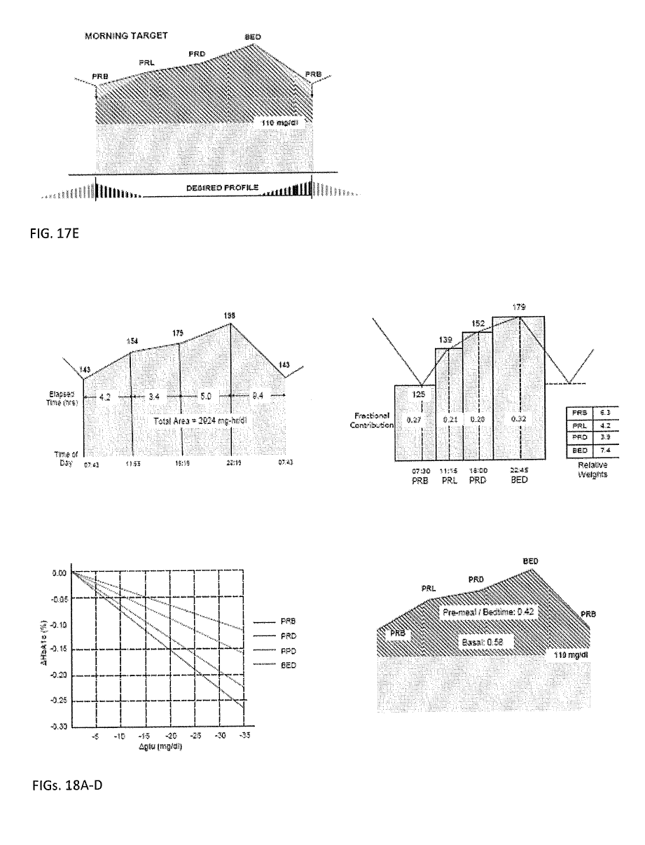

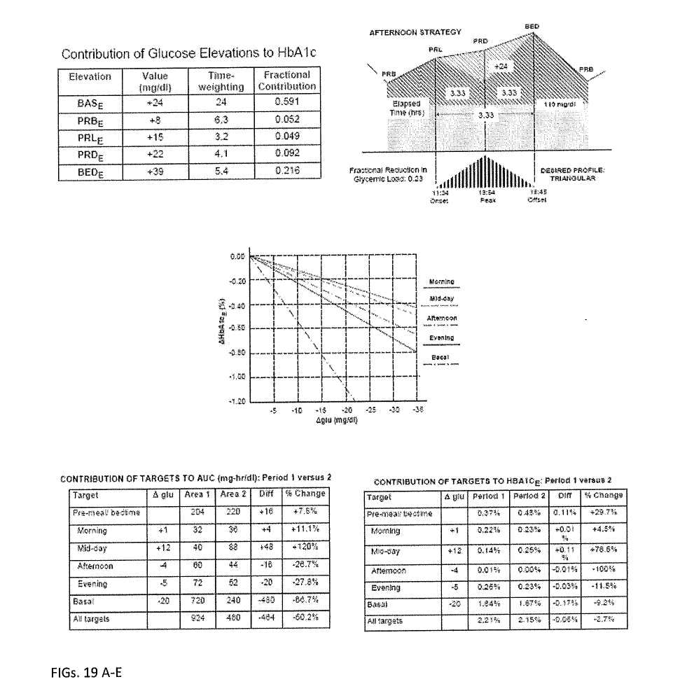

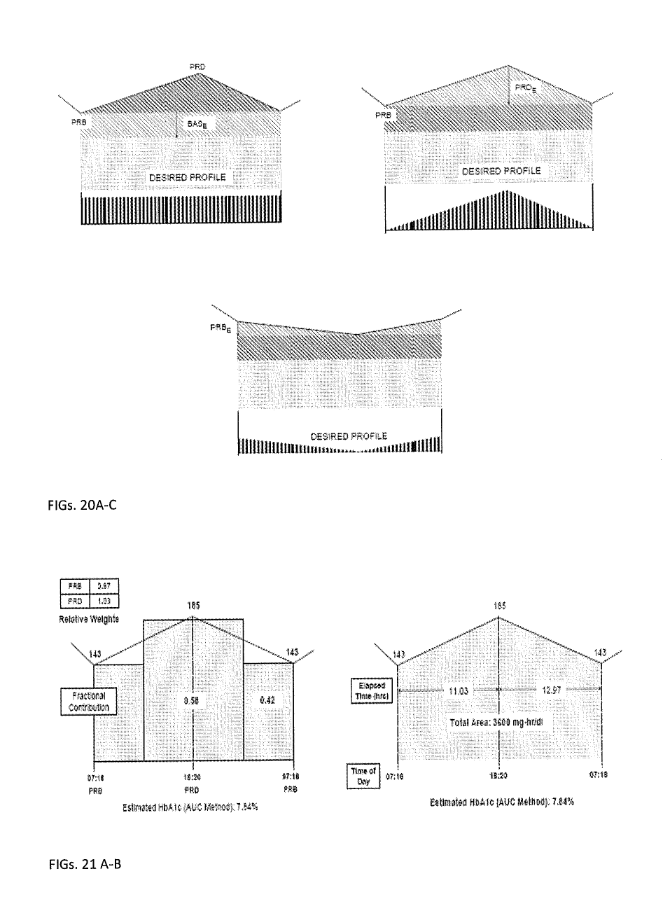

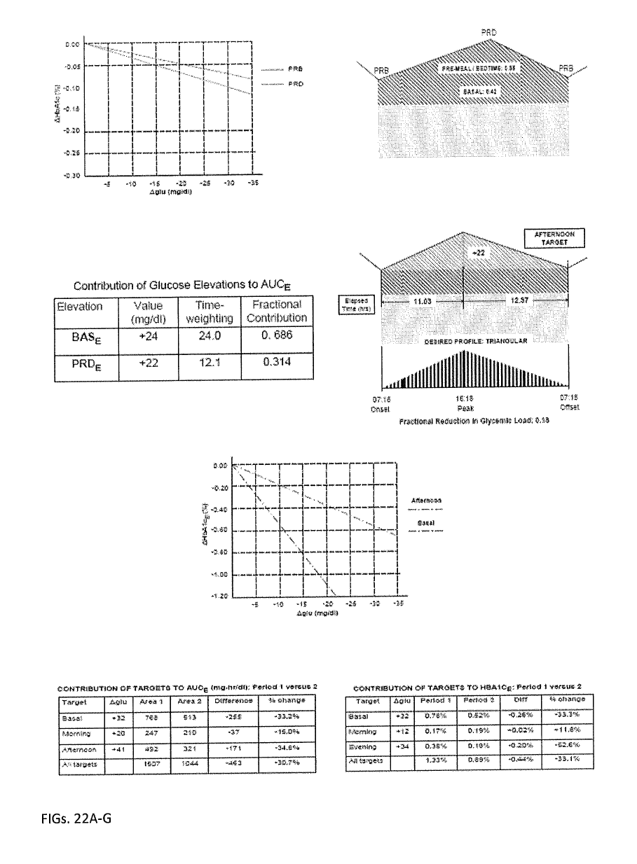

Fractional contribution to HbA1cE of:
Basal target: [0.02828*BAS_{E}]/[0.02828*BAS_{E}+0.01303*PRB_{E}+0.00624*PRL_{E}+0.00670*PRD_{E}+0.00938*BED_{E}]
Morning target: [0.01303*PRB_{E}]/[0.02828*BAS_{E}+0.01303*PRB_{E}+0.00624*PRL_{E}+0.00670*PRD_{E}+0.00938*BED_{E}]
Mid-day target: [0.00624*PRL_{E}]/[0.02828*BAS_{E}+0.01303*PRB_{E}+0.00624*PRL_{E}+0.00670*PRD_{E}+0.00938*BED_{E}]
Afternoon target: [0.00670*PRD_{E}]/[0.02828*BAS_{E}+0.01303*PRB_{E}+0.00624*PRL_{E}+0.00670*PRD_{E}+0.00938*BED_{E}]
Evening target: [0.00938*BED_{E}]/[0.02828*BAS_{E}+0.01303*PRB_{E}+0.00624*PRL_{E}+0.00670*PRD_{E}+0.00938*BED_{E}]
   The treatment targets are defined as shown in FIGS. 17A-E. The displays for the 4-point profile are similar to the displays for the 7-point profile. FIGS. 18A-D and 19A-E illustrate 4-point profile displays.

The system may also use a two-point profile to determine a treatment plan for a patient. The two point profile typically consists of PRB and PRD. Predicting HbA1c using the AUC for a 2-point profile is given by the expression:

Total AUC=t_{PRB}*PRB+t_{PRD}*PRD

where tₙ is the mean of the sampling intervals around reading n. Since there are only 2 measurements, t_{pRB} and t_{PRD} are both equal to 12 hours. Thus,

Total AUC=12*(PRB+PRD)

The estimated HbA1c for the patient may be derived from the ADAG study equation.

Fractional contribution of readings to HbA1c—the fractional contribution of reading n to HbA1c is given by the following:

kₙ*readingₙ/AUC

Identifying treatment targets—It may be shown that AUC_{E} is given by the formula:

AUC_{E}=24*BAS_{E}+12*PRB_{E}+12*PRD_{E}

The fractional reduction in the increase of HbA1c is given by:

coefficientₙ*elevationₙ/AUC_{E}

For the regression method, the most appropriate expression relating HbA1 c to two readings is:

HbA1c=Constant+k_{PRB}*PRB+k_{PRD}*PRD

The parameters may be derived from the population-based study.
The patient's HbA1c may be estimated from the above expression by substituting the patient's values for the above terms into the expression. The fractional contribution of each reading may be obtained directly from the above formulas:

kₙ*readingₙ/Σkᵢ*readingᵢ

From the formula for AUC_{E}, the most appropriate formula for HbA1cE is:

HbA1c_{E}=Constant+c_{BASE}*BAS_{E}+c_{PRB}*PRB_{E}+c_{PRD}*PRD_{E}

where the coefficients are derived from the population study. The fractional reduction in the increase of HbA1c from normalizing an elevation is:

coefficientₙ*readingₙ/Σ coefficientᵢ*readingᵢ

Parameters for the 2-point glucose profile may be developed in the same manner as for the 4-point glucose profile. Linear regression may be used to examine the relationship between HbA1c and a) total AUC; and b) a model containing the two readings. The following results were obtained:

HbA1c versus AUC (R = 0.752; P < 0.001)

| Variable | Coefficient | Std Deviation | Tolerance | P-value |
|---|---|---|---|---|
| Constant | 3.275 | 0.313 | — | <0.001 |
| Total AUC | 0.00107 | 0.00008 | 1.000 | <0.001 |

HbA1c versus 2-point profile (R = 0.752; P < 0.001

| Variable | Coefficient | Std Deviation | Tolerance | P-value |
|---|---|---|---|---|
| Constant | 3.275 | 0.314 | — | <0.001 |
| PRB | 0.01219 | 0.00244 | 0.543 | <0.001 |
| PRD | 0.01340 | 0.00218 | 0.543 | <0.001 |

Likewise, regression was used to examine h relationship between bkicE and the elevations.

HbA1c_{E} versus model (R = 0.754; P < 0.001)

| Variable | Coefficient | Std Deviation | Tolerance | P-value |
|---|---|---|---|---|
| Constant | 0.022 | 0.146 | — | NS |
| BAS_{E} | 0.02529 | 0.00190 | 0.986 | <0.001 |
| PRB_{E} | 0.01770 | 0.00595 | 0.865 | 0.003 |
| PRD_{E} | 0.01522 | 0.00282 | 0.858 | <0.001 |

The expressions were re-derived on the 97 subjects in the derivation set. HbA1c and HbA1c_{E} were predicted for 53 subjects in the validation set by substituting patient values into the new models. Simple linear regression was then used to compare observed versus predicted values. Observed HbA1c for the validation group (7.55±1.62%) was again lower than that predicted from the AUC method (7.56±1.41%) or model (7.60±1.43%). However, correlations between observed HbA1c and the two predicted values were high (R=0.814 and 0.807, respectively; P<0.001). Similar results were obtained for HbA1c_{E}.

The entire sample was used to cross-validate the fractional contributions of PRB and PRD to HbA1c from the two methods:

| Reading | AUC method | Model | R | P-value |
|---|---|---|---|---|
| PRB | 46.7 ± 5.5% | 44.4 ± 5.5% | 1.00 | <0.001 |
| PRD | 53.3 ± 5.5% | 55.6 ± 5.5% | 1.00 | <0.001 |

The same approach was used to cross-validate fractional contributions of FE and BEDE to HbA1c_{E}:

| Reading | AUC method | Model | R | P-value |
|---|---|---|---|---|
| BAS_{E} | 60.5 ± 32.6% | 57.5 ± 32.3% | 0.998 | <0.001 |
| PRB_{E} | 7.7 ± 21.1% | 8.7 ± 22.2% | 0.996 | <0.001 |
| PRD_{E} | 31.8 ± 33.3% | 33.8 ± 33.8% | 0.999 | <0.001 |

For the AUC method, the following equations may be used:

AUC=12*(PRB+PRD)

HbA1c=3.275+0.00107*Total AUC

Fractional contribution to Hba1c of:
PRB: PRB/(PRB+PRD)
PRD: PRD/(PRB+PRD)

AUC_{E}=24*BAS_{E}+12*PRB_{E}+12*PRD_{E}

Fractional contribution to HbA1c_{E} of:
Basal target: 2*BAS_{E}/[2*BAS_{E}+PRB_{E}+PRD_{E}]
Morning target: PRB_{E}/[2*BAS_{E}+PRB_{E}+PRD_{E}]
Afternoon target: PRD_{E}/[2*BAS_{E}+PRB_{E}+PRD_{E}]
   For the regression method, the following equations may be used:

HbA1c=3.275+0.01219*PRB+0.01340*PRD

Fractional contribution to HbA1 c of:
PRB: 0.01219*PRB/[0.01219*PRB+0.01340*PRD]
PRD: 0.01340*PRD/[0.01219*PRB+0.01340*PRD]

HbA1c_{E}=0.022+0.02529*BAS_{E}+0.01770*PRB_{E}+0.01522*PRD_{E}

Fractional contribution to HbA1c_{E} of:
Basal target: 0.02529*BAS_{E}/[0.02529*BAS_{E}+0.01770*PRB_{E}+0.01522*PRD_{E}]
Morning target: 0.01770*PRB_{E}/[0.02529*BAS_{E}+0.01770*PRB_{E}+0.01522*PRD_{E}]
Evening target: 0.01522*PRD_{E}/[0.02529*BAS_{E}+0.01770*PRB_{E}+0.01522*PRD_{E}]

FIGS. 20A-C show the three targets for a 2-point glucose profile. FIGS. 21A-B and 22A-G show the displays for a 2-point glucose profile, which are similar to those of the 4-point glucose profile.

The system also includes a one-point profile that can be used to determine a treatment plan for a patient. The one-point profile is usually the reading taken by patients testing once daily. The system may provide an estimate of HbA1c from the ADAG study equation. Regression on 150 stable subjects on insulin showed a significant relationship described by the following:

HbA1c=4.062+0.02234*PRB(R=0.674; P<0.00)

The expression was re-derived from the derivation set and used to predict HbA1c in the validation set. Observed values (7.55±1.62%) were higher than predicted (7.52±1.16%), but the correlation was still high for a one-point profile (R=0.793; P<0.001).

The system can show the targets covered by common insulin combinations, derive the fractional contribution to glycemic load for targets covered by each insulin dose, and identify the untreated targets. Additionally, the formulas may be used to determine which of the insulin doses in a treatment combination should be increased for patient treatment planning.

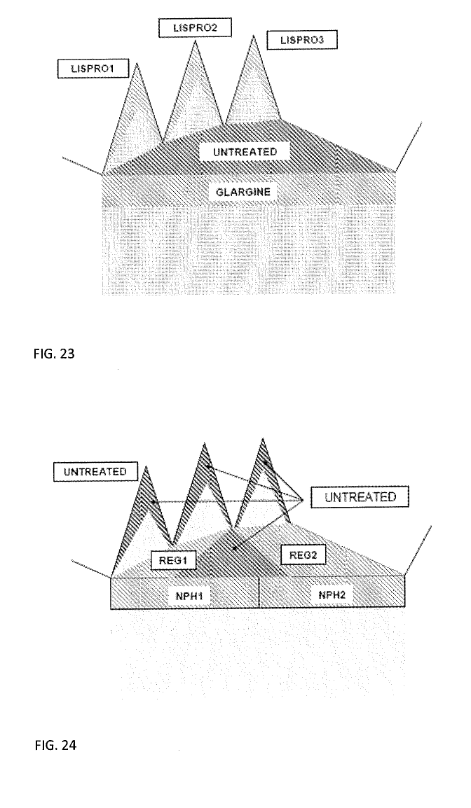

A Glargine/Lispro combination as shown in FIG. 23 covers an elevated basal glucose and 3 postprandial peaks. In addition, additional Lispro may be given to make up for the fact that pre-meal elevations above baseline are not treated. Since BAS is equal to the lowest of PRB, PRL, PRD and BED, one of the four associated elevations (PRB_{E}, PRL_{E}, PRD_{E}, and BED_{E}) is zero. The fractional glycemic load covered by each dose in this combination is given by the following:

LISPRO1=t_{PPB}*PPB_{E}

LISPRO2=t_{PPL}*PPL_{E}

LISPRO3=t_{PPD}*PPD_{E}

GLAR=24*BAS_{E}

TOT=LISP1+LISP2+LISP3+GLAR

LISPRO1 (fraction)=LISP1/TOT

LISPRO2 (fraction)=LISP2/TOT

LISPRO3 (fraction)=LISP3/TOT

GLAR (fraction)=GLAR/TOT

A NPH/regular combination as shown in FIG. 24 shows that there are two basal readings (BASE1 and BASE2), each of which is covered by an NPH dose. Accordingly, two of the basal elevations are zero. The customary targets for regular insulin are the pre-lunch and bedtime elevations. However, there are circumstances when pre-breakfast or pre-dinner glucoses are higher than other times of the day. The fractional glycemic load covered by each injection is given by:

NPH1=12*BAS_{E}

NPH2=12*BAS_{E}

REG1=t_{A}*PRL_{E}

REG2=t_{BED}*BED_{E}

TOT=NPH1+NPH2+REG1+REG2

NPH1 (fraction)=NPH1/TOT

NPH2 (fraction)=NPH2/TOT

REG1 (fraction)=REG1/TOT

REG2 (fraction)=REG2/TOT

The treatment targets may exactly coincide with the most appropriate insulin preparation, either in terms of onset, configuration, or duration. Accordingly, eliminating the target elevation may not produce the anticipated reduction in HbA1c, and effects that proceed over into other targets may influence the possibility of hypoglycemia at other times. Nevertheless, the system finds a match for each target and makes recommendations by identifying potential times for each injection, establishes the time of the target reading in relationship to these events, calculates the required duration of effect (i.e., its time dimension), and then compares the onset and duration of different preparations to these parameters. An advisory may then be delivered about the strategy with the closest match to these requirements.

Embodiments of the present invention may use two criteria to identify the most appropriate treatment plan: a) time to peak effect and b) duration of action. The system assumes that two classes of insulin (regular and intermediate) may be used at any of four potential injection times (breakfast, lunch, dinner, and bedtime). Glargine is the preferred agent for basal hyperglycemia, while rapidly-acting insulin is the preferred agent for PP elevations. The system establishes a window of peak effect for the eight combinations of drug/injection using values from on-line references (e.g., UpToDate® and MicroMedex®). The following table summarizes these properties:

| Preparation | Time to Peak Effect | Duration of Action |
|---|---|---|
| Regular | 2 to 4 hours | 5 to 8 hours |
| Intermediate | 6 to 10 hours | 18 to 24 hours |

The following summarizes the analysis for a hypothetical target BEDE in a patient who eats breakfast at 08:30 AM, lunch at 1:30 PM, and dinner at 6:00 PM. The target occurs at 9:00 PM and lasts from 7:30 PM to 2:00 AM.

| Recom- | Event | Target | | |
|---|---|---|---|---|
| mendation | Time | Time | Peak Effect | Qualifies |
| Breakfast | | | | |
| Regular | 08:30 AM | 09:00 PM | 10:30 AM-12:30 PM | No |
| Intermediate | 08:30 AM | 09:00 PM | 02:30 PM-04:30 PM | No |
| Lunch | | | | |
| Regular | 01:30 PM | 09:00 PM | 03:30 PM-05:30 PM | No |
| Intermediate | 01:30 PM | 09:00 PM | 07:30 PM-11:30 PM | Yes |
| Dinner | | | | |
| Regular | 06:00 PM | 09:00 PM | 08:00 PM-10:00 PM | Yes |
| Intermediate | 06:00 PM | 09:00 PM | 12:00 M-02:00 AM | No |
| Bedtime | | | | |
| Regular | 09:00 PM | 09:00 PM | N/A | No |
| Intermediate | 09:00 PM | 09:00 PM | N/A | No |

Only two recommendations have a window for peak effect that includes the target time. The remaining combinations are therefore disregarded by the system. The system then considers the second criteria, namely comparing the duration of the target to the duration of insulin effect:

| Recom- | Event | Target | Target | Insulin | |
|---|---|---|---|---|---|
| mendation | Time | Time | Duration | Duration | Choice |
| Lunch | 01:30 PM | 09:00 PM | | | |
| Inter- | 01:30 PM | 09:00 PM | 6.5 hours | 18 to 24 hours | |
| mediate | | | | | |
| Dinner | 06:00 PM | 09:00 PM | | | |
| Regular | 06:00 PM | 09:00 PM | 6.5 hours | 5 to 8 hours | ***** |

In this case, the recommendation is to administer regular insulin at 6:00 PM to cover the 09:00 PM glucose elevation. The system does not make dosage recommendations because it is assumed that the patient will increase doses a few units at a time and evaluate treatment response at each step. The system may calculate the probability that hypoglycemia will develop at four sampling times (PRB, PRL, PRD, and BED) on long-term follow-up. It is assumed that patients are not at risk for hypoglycemia during PP periods. The method may use a modified version of a validated logistic model using glucose mean (GLUMEAN) and standard deviation (GLUSD) derived from the four readings. Accordingly, estimates only for 7- and 4-point glucose profiles are estimated. The system may use a dichotomous dependent variable (occurrence of hypoglycemia) instead of a polychotomous outcome based upon hypoglycemia rates. It also may use log-transformed values instead of raw glucose values. The model was derived on 78 stable, insulin-treated patients. It estimates the probability of observing a hypoglycemic event during an eight week period of intensified SMBG. The following table shows the characteristics of this model:

| Variable | Coefficient | Std Error | Odds Ratio | OR 95% CI |
|---|---|---|---|---|
| Log | −7.697 | 2.11 | 0.000454 | 0.684E−05 to |
| (GLUMEAN) | | | | 0.302E−01 |
| Log (GLUSD) | 40.24 | 10.2 | 0.299E+18 | 0.487E+09 to |
| | | | | 0.184E+27 |
| Constant | 25.70 | 9.12 | 0.145E+12 | 0.186E+04 to |
| | | | | 0.112E+20 |

The probability of hypoglycemia is given by the expression: P=exp(Σ)/[1+exp(Σ)] where Σ=25.70−7.697*log(GLUMEAN)+40.24*log(GLUSD). The model was validated by calculating the probability for an independent sample of 93 patients, grouping them into quartiles based upon risk, and following them for up to one year. The following table shows the hypoglycemia rate, the probability of developing at least one episode, and the probability that the rate exceeds the median value among those having events:

| | Quartile 1 | Quartile 2 | Quartile 3 | Quartile 4 | P-value |
|---|---|---|---|---|---|
| Events/4 weeks | 0.037 ± | 0.065 ± | 0.557 ± | 1.16 ± | <0.001 |
| | 0.090 | 0.145 | 0.774 | 1.25 | |
| P (hypogly)* | 20.8% | 22.7% | 75.0% | 82.6% | <0.001 |
| P (high rate)** | 0.0% | 4.5% | 37.5% | 65.2% | <0.001 |

An estimate for the risk of hypoglycemia before breakfast, before lunch and at bedtime may also be provided. The risk is based upon validated models derived in the same manner as the general model. The only difference is that specific readings (e.g. PRB) are used to predict events over specific intervals of the day (06:00 AM to 10:00 AM). In derivation patients monitored for eight weeks, PRB was used to develop a model for the probability that patients would develop hypoglycemia at breakfast. This model is described by the expression: P=exp(Σ)/[1+exp(Σ)] where Σ=33.36−7.935*log(PRBMEAN)+18.46*log(PRBSD). Eighty validation patients were grouped into quartiles by their estimated risk and followed for hypoglycemic events occurring between 06:00 and 10:00. The following results were obtained after one year:

| | Quartile 1 | Quartile 2 | Quartile 3 | Quartile 4 | P-value |
|---|---|---|---|---|---|
| Events/4 weeks | 0.021 ± | 0.024 ± | 0.077 ± | 0.325 ± | <0.001 |
| | 0.054 | 0.042 | 0.160 | 0.439 | |
| P (hypogly)* | 15.0% | 25.0% | 25.0% | 80.0% | <0.001 |
| P (high rate)** | 5.0% | 0.0% | 20.0% | 55.0% | <0.001 |

PRL was used to develop a similar model for hypoglycemia occurring before lunch. It is given by the expression P=exp(Σ)/[1+exp(Σ)] where Σ=18.43−4.996*log(PRLMEAN)+17.28*log(PRLSD). The following table shows hypoglycemia events between 10:00 and 14:00 in 84 validation subjects followed for up to one year:

| | Quartile 1 | Quartile 2 | Quartile 3 | Quartile 4 | P-value |
|---|---|---|---|---|---|
| Events/4 weeks | 0.027 ± | 0.045 ± | 0.094 ± | 0.331 ± | <0.001 |
| | 0.061 | 0.083 | 0.230 | 0.363 | |
| P (hypogly)* | 19.0% | 28.6% | 19.0% | 71.4% | 0.001 |
| P (high rate)** | 9.5% | 14.3% | 19.0% | 66.7% | <0.001 |

The analysis for dinner and bedtime was complicated by low rates of hypoglycemia. The model for dinner was given by: P=exp(Σ)/[1+exp(Σ)] where Σ=34.65−8.796*log(PRDMEAN)+22.17*log(PRDSD). Although the model was somewhat helpful, it failed to differentiate between patients who did or did not develop hypoglycemia on long-term follow-up. The present embodiment therefore does not estimate the risk for this time. The model for hypoglycemia at bedtime is instead given by: P=exp(Σ)/[1+exp(Σ)] where Σ=29.65−8.646*log(BEDMEAN)+35.98*log(BEDSD). Because this model has limited ability to discriminate among low- and high-risk patients on long-term follow-up, Insulin Manager assigns only two categories of risk:

| | Low Risk | High Risk | P-value |
|---|---|---|---|
| Events/4 weeks | 0.011 ± 0.048 | 0.097 ± 0.270 | 0.011 |
| P (hypogly) | 7.1% | 27.9% | 0.012 |
| P (high rate) | 2.4% | 18.6% | 0.015 |

Conventional systems calculate glucose mean and standard deviation for each time of day. However, the range for hypoglycemia is much smaller than for hyperglycemia, and values are far more likely to be high than low. As a result, the distribution of values at any time of day is unlikely to be normal, and SD should not be used to determine the likelihood that a random reading will be low (28-30). The present system provides a more usable format by log-transforming glucose values, deriving a mean value and SD from the transformed data, constructing a normal distribution based upon these parameters, and then using the distribution to estimate the probability that any reading will fall below a series of critical values. The log transformation is preferably used because a normal glucose is about 100 mg/dl, an extremely low value is 10 mg/dl, and an extremely high value is 1000 mg/dl. Transforming these values (e.g. to the base 10) creates a scale with a center at 2 and extreme values at 1 and 3. This analysis is possible when there are several readings for that time of day.

Parametric estimation of hypoglycemia risk requires selecting the appropriate theoretical distribution and then using the patient's own data to calculate its parameters. There is ample evidence that a logarithmic transformation of raw glucose values is appropriate for this purpose. Pooled data from 182 stable, insulin-treated patients was used to illustrate this effect. The distribution of over 33,000 glucose values was positively skewed—that is, it had a long tail to the right and most observations were to the left of the mean. Log transformation “pulled in” the extremely high values, creating a symmetrical distribution. The probability that a random glucose sample will be <60 mg/dl is therefore given by the expression:

∫f(x) dx

for −∞≦x≦log(60) where f(x)=1/sqr(2πσ²)*exp[−(x−μ)²/2σ²], μ=mean value, and σ=standard deviation (SD) of the subject's log transformed glucose values for the reading of interest.

Once treatment is intensified, the distribution of log transformed glucose shifts to a lower value. The area under the shifted curve bounded by −∞ and log(60) increases, placing the patient at greater risk for hypoglycemia. For a target that is normalized, the mean becomes the user-defined reference value. The area under the curve<log(60) can be estimated as long as SD is known. The problem is that one cannot assume that SD remains stable as the curve shifts to the left or right. The reason is that the variance of raw blood glucose values increases with the mean. To illustrate this phenomenon, the glucose mean and SD was calculated for 182 stable patients. Linear regression showed that glucose SD was strongly correlated with its mean value according to the expression:

Glucose SD=6.76+0.313*Glucose Mean (r=0.686; P<0.001)

Recall that log transformation converts a positively skewed distribution into a symmetrical one. Fortunately, it also stabilizes the variance in circumstances where SD is a percentage of the mean value. The 182 subjects were divided into 7 categories according to their mean glucose: ≧100 and <125; ≧125 and <150; ≧150 and <175; ≧175 and <200; ≧200 and <225; ≧225 and <250; and ≧250. The SD of log glucose was strikingly constant across the categories: 0.316±0.095; 0.359±0.075; 0.346±0.077; 0.375±0.110; 0.396±0.095; 0.358±0.074; and 0.337±0.094, respectively. Neither one-way analysis of variance nor the Kruskal-Wallis test showed that these differences were significant. This observation suggests that log transformation of glucose stabilizes the variance across patients with a broad range of glucose values. The system compares the patient's risk after treatment to a hypothetical standard patient by issuing the advisory: “The risk of hypoglycemia in a patient at goal with a glucose variance similar to your patient is XX%” where:

XX%=100*∫f(x)dx

for −∞≦x≦log(60) where f(x)=1/sqr(2πσ²)* exp[−(x−REF)²/2σ²], REF=the glucose target selected by the user, and σ=SD of the subject's log transformed glucose values for the reading of interest.

The system performs a second assessment of hypoglycemia risk based upon simple enumeration. Recall that the reading of interest is the average of multiple readings. This analysis assumes that each of the individual readings is lowered by the same amount as the average is reduced. For example, suppose a PRD of 151 is the average of 6 readings: 98, 164, 145, 182, 193 and 123. Normalizing PRD requires a drop of 151−110=41 mg/dl. Assuming that treatment is equally effective for the observed range of glucoses, the 6 readings would also be reduced to 98−41=57; 164−41=123; 145−41=104; 182−41=141; 193−41=152, and 123−41=82. Note that one of the values contributing to PRD (98 mg/dl) would reach the hypoglycemic threshold (57 mg/dl) if it responds to the same degree as the target. If the patient encounters similar values after treatment is started, he or she will eventually develop hypoglycemia before the target is achieved. This projection triggers a warning from the system.

The following displays may be produced for 7- and 4-point profiles using the present system:

“Your estimated risk of hypoglycemia over an eight week period is 9.4%. Using this number, an embodiment of a system of the present invention assigns the long-term risk of hypoglycemia to 4 categories: low, low-intermediate, high-intermediate, and high. Your risk is considered to be low. The following table shows what happened to patients in your category when they were followed for up to one year:”

| | Low Risk |
|---|---|
| | Category |
| Number of events over the next year | 0.351 |
| Probability of at least one event | 19.0% |
| Probability of having a rate exceeding | 9.5% |
| the median value | |

“The following table shows the number of low readings for each time of day for the interval that you chose:”

| | Fasting | Pre-Lunch | Pre-Dinner | Bedtime |
|---|---|---|---|---|
| <100 mg/dl | 0 | 2 | 1 | 1 |
| <90 mg/dl | 0 | 1 | 1 | 0 |
| <80 mg/dl | 0 | 0 | 1 | 0 |
| <70 mg/dl | 0 | 0 | 0 | 0 |
| <60 mg/dl | 0 | 0 | 0 | 0 |

“Your readings are used to calculate the probability that readings will fall below a series of critical values for each time of day. This estimate is a statistical analysis of your values and is based upon assumptions that may not be true for all patients:”

| | Fasting | Pre-Lunch | Pre-Dinner | Bedtime |
|---|---|---|---|---|
| <100 mg/dl | 0.9% | 4.3% | 2.8% | 1.2% |
| <90 mg/dl | 0.6% | 3.8% | 2.3% | 1.1% |
| <80 mg/dl | 0.3% | 3.2% | 2.1% | 0.9% |
| <70 mg/dl | 0.1% | 2.8% | 1.9% | 0.7% |
| <60 mg/dl | 0.9% | 1.6% | 1.5% | 0.5% |

The modules may be used independently to address specific problems. For example, one patient might want to know how a new diet has affected his or her glycemic control. Another may want to assess the baseline risk of hypoglycemia before starting a new exercise regimen. The modules may also be used in sequence to manage long-term insulin treatment.

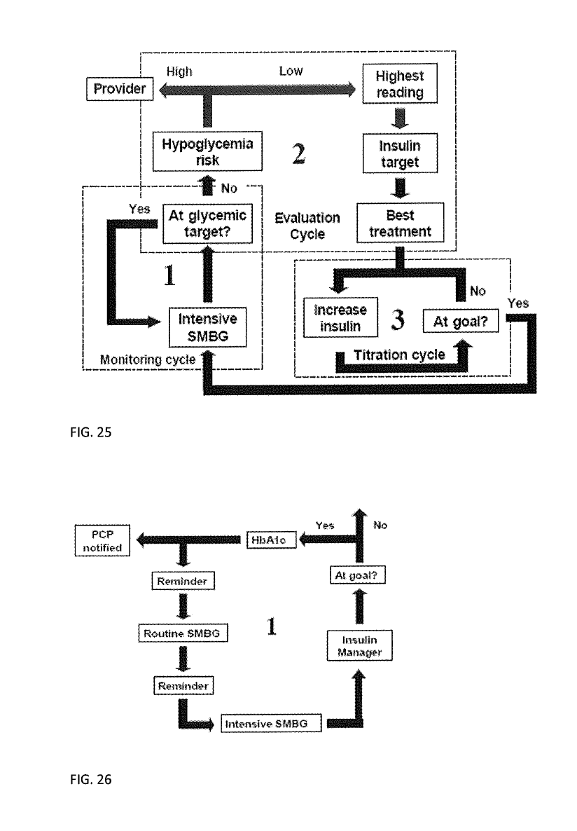

The methodology for self-management is based upon the usual way that providers interpret SMBG data and adjust insulin. This process consists of the following steps: (a) assessing the level of glycemic control; (b) evaluating the risk of hypoglycemia in those who need more intensive treatment; (c) identifying the most problematic readings; (d) choosing a target for insulin treatment; (e) selecting the type of insulin and injection time that best covers the target; (f) increasing the dose by a few units at a time and checking the response; (g) repeating (f) until blood glucose reaches a certain level; (h) going back to routine SMBG; and (i) repeating the entire process at regular intervals until all readings reach their target values. The steps are shown in FIG. 25 and grouped into three cycles: The tasks in Cycle 1 relate to SMBG, in Cycle 2 to evaluation, and in Cycle 3 to insulin titration.

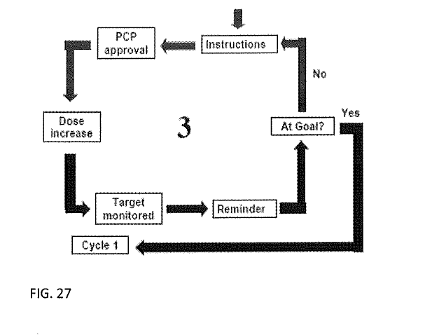

Cycle 2 starts when the patient has assembled a sufficient number of readings for interpretation. The first step is to estimate HbA1c from the glucose readings. The system uses this approach so that changes may be made more quickly than those based upon HbA1c alone. If the estimated HbA1c is at a specified goal, the patient is switched to Cycle 1 shown in FIG. 26. In this Cycle, the patient gives blood for a confirmatory measurement, the provider is notified, and instructions to start routine SMBG are sent. Routine monitoring is done to screen for hypo- and hyperglycemia or to diagnose symptoms. After a period specified by the provider, the patient is sent further instructions to start Intensive SMBG. The instructions include the start date, timing of measurements, number of readings per day, how measurements are to be rotated across testing times, required number of readings for each time of day, and expected duration of monitoring. At the appropriate time, the patient is instructed to upload his or her readings and analyze the results. If the patient is not at goal, he or she is switched to Cycle 2. The number of hypoglycemic events and sampling interval is read, an event rate, and then terminates the protocol and notifies the provider if it exceeds the latter's specifications. The system then calculates an expected long-term hypoglycemia rate using a validated algorithm and again terminates the protocol if the patient's risk group is higher than one acceptable to the provider. If the projected risk is acceptable, the system identifies the readings that contribute the most to HbA1c. This function alerts the patient to behaviors such as excessive carbohydrate intake at a specific meal that contribute to poor glycemic control at a specific time of day. The system then identifies the most important insulin targets and recommends the strategy that best covers the target. No dosing recommendations are made because the system assumes that the patient will adjust the insulin dose 2-3 units at a time and monitor the response in Cycle 3, which is shown in FIG. 27.

At the start of the titration cycle, the system provides a reminder to the patient about the recommended injection time, type of preparation, current dose, recommended dose, targeted reading, frequency of measurements, number required to assess the response, range for the final value, expected cycle length, and what to do if hypoglycemia occurs. The provider has the option of approving the notification before it is sent on to the patient. After the dose is increased, the patient monitors the target glucose. After a time period specified by the provider, the system may remind the patient to upload his or her blood glucose readings into the system. The system may screen the readings for hypoglycemia, average the last three values, and compare the average to the target range. The protocol terminates if a low value is detected. If the readings are too high, the protocol recycles. The next cycle is initiated by a set of instructions delivered to the patient (with or without the provider's approval). The dose increase may be gradual and specified by the provider. An alternative strategy is to use a dosing algorithm to estimate the next dose based upon the previous response. If the patient is at a specific goal, he or she is switched back to Cycle 1 to do intensive SMBG. The routine cycles until all problematic readings are treated and the patient reaches his or her target for all readings.

Advantages of the present system are that it eliminates practice variations, has evidence-based decision making, requires a provider to formulate a treatment plan instead of making decisions on-the-fly, provides a framework for SMBG, and has a database that may be interrogated for best treatment sequences. Other advantages of the system are that it provides a platform for immediate dissemination of new findings, retrospective and prospective assessments of hypoglycemia risk, rapid titration to goal, and is immediately accessible to those patients having computer access.

Embodiments of the present invention help patients adjust their maintenance insulin regimen. The preferred system interprets readings in aggregate, generates representative glucose profiles, and identifies problematic readings and the best preparations to treat them. The preferred system expects patients to target their readings one-by-one, increase their doses a few units at a time and monitor the response until an acceptable value is reached. In this way, the preferred system emulates the process by which providers would have used the same data. The system may provide multiple pieces of information to the insulin-treated patient including HbA1c estimation, hypoglycemia prediction, and target identification.

Limitations of the regression method for HbA1c estimation are that it uses the patient's own mealtimes but population-derived coefficients. If the patient has unusual mealtimes, the regression methods may be less accurate.

Another limitation is that the system assumes that blood glucose changes in a linear fashion between measured values. This approach overestimates the time-weightings for postprandial readings if the patient returns to baseline before the next meal. This problem is most likely to occur if the interval between two readings is long. In this case, some variation of the proposed profile is more appropriate. In a study of 150 insulin-treated patients, PRL fell to within 5 mg/dl of PRB in about half of the subjects when the interval between breakfast and lunch was ≧5.5 hours. Similar results were obtained for PRD (relative to PRL) and BED (relative to PRD). This observation suggests that, for these patients, the average time for a return to baseline is about 5.5 hours. The system identifies pre-meal or bedtime readings that represent a return to baseline (e.g. within 5 mg/dl of the previous pre-meal value). It then assigns a time-weighting for the PP excursion of ½*[5.5 hours]=2.75 hours. It may also be shown that the time weighting for the next pre-meal reading should be increased by ½*(“interval”−3.5), where “interval” refers to the time between the PP and pre-meal readings.

While the present invention and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the invention, which is to be limited not by the exemplary embodiments but by the appended claims.

What is claimed is:

1. A system for evaluating SMBG data and selecting insulin treatment comprising:
a memory configured to store code;
a processor communicating with the memory storing code causing the processor to:
retrieve data comprising a plurality of blood glucose readings from the memory;
select a time period;
calculate a hemoglobin A1c (HbA1c) for the selected time period;
estimate adjustments to the calculated HbA1c for changes in the blood glucose readings;
calculate a contribution of each blood glucose reading from the retrieving to glycemic load; and
generate a treatment plan for regulating blood glucose in the patient.

2. The system for evaluating SMBG data and selecting insulin treatment of claim 1, wherein said processor further evaluates a possibility of the patient having a hypoglycemic event and generates a risk assessment score.

3. The system for evaluating SMBG data and selecting insulin treatment of claim 1, wherein said processor further identifies insulin targets having the greatest effect on glycemic control of the patient.

4. The system for evaluating SMBG data and selecting insulin treatment of claim 1, wherein the processor generates a treatment plan by selecting a type of insulin for the patient to inject.

5. The system for evaluating SMBG data and selecting insulin treatment of claim 1, wherein the processor generates a treatment plan by providing one or more patient insulin injection times.

6. The system for evaluating SMBG data and selecting insulin treatment of claim 1, wherein the contributions of each blood glucose reading are fractional contributions.

7. The system for evaluating SMBG data and selecting insulin treatment of claim 1, wherein the HbA1c is calculated from a 7-point blood glucose profile having blood glucose readings from seven different times of a day.

8. The system for evaluating SMBG data and selecting insulin treatment of claim 1, wherein the HbA1c is calculated from a 4-point blood glucose profile having blood glucose readings from four different times of a day.

9. The system for evaluating SMBG data and selecting insulin treatment of claim 1, wherein the HbA1c is calculated from a 2-point blood glucose profile having blood glucose readings from two different times of a day.

10. The system for evaluating SMBG data and selecting insulin treatment of claim 1, wherein the HbA1c is calculated from a single-point blood glucose profile having blood glucose readings from one time of a day.

11. The system for evaluating SMBG data and selecting insulin treatment of claim 1, wherein said processor calculates an area under a glucose concentration time curve to determine the HbA1c.

12. The system for evaluating SMBG data and selecting insulin treatment of claim 1, wherein said processor performs multiple linear modeling computations to calculate the HbA1c.

13. A method for providing advisories for the insulin dosage of a patient, comprising the steps of:
providing a plurality of blood glucose readings;
selecting a time period;
projecting a hemoglobin A1c (HbA1c) for the selected time period;
estimating adjustments to the calculated HbA1c for changes in the blood glucose readings;
calculating a contribution of each reading from said to excess glycemic load; and
providing treatment recommendations for regulating blood glucose in the patient.

14. The method for providing advisories on the insulin dosage of the patient according to claim 13, wherein said estimating step further includes a step of defining independent contributions of each blood glucose reading from said providing step to glycemic load.

15. The method for providing advisories on the insulin dosage of the patient according to claim 13, wherein said estimating step further includes a step of employing weighted values to account for different exposure times.

16. The method of claim 15, wherein the exposure times include pre-meal and bedtime blood glucose reading times.

17. The method for providing advisories on the insulin dosage of the patient according to claim 13, wherein said evaluating step further comprises the step of forecasting hypoglycemia by using pre-meal and bedtime blood glucose readings.

18. The method of claim 13, wherein said estimation step calculates the HbA1c by determining an area under a glucose concentration time curve.

19. The method of claim 13, wherein said estimation step calculates the HbA1c by performing multiple linear modeling computations.

20. The method of claim 13, wherein the blood glucose readings comprise one of a 7-point blood glucose profile and a 4-point blood glucose profile.
